(19) United States
(12) Patent Application Publication
(10) Pub. No.: US 2026/0361769 A1
(43) Pub. Date: Nov. 12, 2026

(54) SYSTEMS AND METHODS FOR AUTOMATION OF POLICY MANAGEMENT FOR USER ENTITLEMENTS

(71) Applicant: JPMorgan Chase Bank, N.A., New York, NY (US)

(72) Inventors: Jasdeep K. Katariya, Houston, TX (US); Bret Douglas Goldsmith, Sugarland, TX (US)

(73) Assignee: JPMorgan Chase Bank, N.A., New York, NY (US)

(21) Appl. No.: 19/261,451

(22) Filed: Jul. 7, 2025

Related U.S. Application Data
(63) Continuation-in-part of application No. 19/203,372, filed on May 9, 2025.

(51) Int. Cl. H04L 9/40

(52) U.S. Cl. CPC H04L 63/20; H04L 63/10

(57) ABSTRACT

Aspects of the subject disclosure may include, for example, policy management automation for user entitlements. Plain English descriptions of access policies are converted into machine-readable policies using generative AI. Database queries may also be generated based on policies and data model descriptions. Policies are verified using test cases and test data, stored for version control, published to implementation layers, and deployed for real-time enforcement. The system integrates with policy management tools, enabling dynamic updates to policies in response to changes, ensuring compliance and adaptability to evolving security requirements.. Other embodiments are disclosed.

### CROSS-REFERENCE TO RELATED APPLICATION

This application is a continuation-in-part application of U.S. patent application Ser. No. 19/203,372 filed May 9, 2025, the content of which is incorporated by reference herein in its entirety.

### FIELD OF THE DISCLOSURE

The subject disclosure relates to policy management for user entitlements.

### BACKGROUND

User entitlements refer to the permissions and access rights assigned to users within a system, determining what resources they can access and what actions they can perform based on predefined policies. Traditional systems often rely on static roles and permissions when defining user entitlements. These systems typically embed access control logic within applications, leading to inconsistencies and challenges in policy updates. As a result, organizations that rely on static roles and permissions typically face difficulties in maintaining fine-grained access control and adapting to evolving security requirements.

### SUMMARY OF THE DISCLOSURE

One or more aspects of the subject disclosure include a non-transitory machine-readable medium, comprising executable instructions that, when executed by a computing device including a processor, facilitate performance of operations. The operations may include providing, to a generative AI system, plain English descriptions of user entitlements, wherein the descriptions define access control rules for users within a system; receiving, from the generative AI system, a user entitlements policy generated from the plain English descriptions of user entitlements, wherein the user entitlements policy specifies access control rules in a machine-readable format; receiving, from the generative AI system, at least one machine-readable rule configured to operate in compliance with the user entitlements policy; and storing the user entitlements policy and the machine-readable rule(s) in a source control system, wherein the source control system manages version control and tracks changes to the user entitlements policy and the machine-readable rule(s).

Although plain English is used herein as an example input to the generative AI system, this is not meant to be limiting. For example, in some embodiments, any natural human language may be used without loss of generality. Further, in some embodiments, structured data or a combination of structured data and natural human language may be used as input to the generative AI. For example, structured data may include a spreadsheet including a comma separated list of access profiles, where the profiles represent users’ access rights to certain datasets.

One or more aspects of the subject disclosure include a non-transitory machine-readable medium, comprising executable instructions that, when executed by a server including a processor, facilitate performance of operations. The operations may include providing, to a generative AI system, plain English descriptions of user entitlements, wherein the plain English descriptions define access control rules for users within a system; providing, to the generative AI system, a data model description that describes a structure of a data source accessible by the system; receiving, from the generative AI system, a user entitlements policy generated from the plain English descriptions of user entitlements, wherein the user entitlements policy specifies access control rules for accessing the data source; receiving, from the generative AI system, at least one query configured to query the data source in compliance with the user entitlements policy; and storing the user entitlements policy and the at least one query in a source control system, wherein the source control system manages version control and tracks changes to the user entitlements policy and the at least one query.

One or more aspects of the subject disclosure include a method, comprising: receiving, by a processing system including a processor, plain English descriptions of user entitlements, wherein the plain English descriptions define access control rules for users within the processing system; providing, by the processing system, to a generative AI system, the plain English descriptions of user entitlements along with a prompt to generate a user entitlements policy; receiving, by the processing system, from the generative AI system, the user entitlements policy; and enforcing, by the processing system, the user entitlements policy when a user requests access to a data source.

One or more aspects of the subject disclosure include a non-transitory machine-readable medium storing executable instructions which, when executed by a computing device having at least one processor, facilitate performance of operations. The operations may include receiving plain English descriptions of access policies for a specified domain, wherein the plain English descriptions define access control parameters for users, roles, and permissions. The operations may further include transmitting the received plain English descriptions along with a predefined structured prompt to a generative artificial intelligence (AI) module. The operations may also include obtaining, from the generative AI module, a set of identified components, including user designations, permitted actions, and associated assets extracted from the plain English descriptions. Additionally, the operations may include supplying the generative AI module with data model specifications that describe the structure, interrelationships, and attributes of data sources governed by the access policies. The operations may further include receiving, from the generative AI module, machine-readable access control policies generated based on the plain English descriptions and the data model specifications. The operations may also include verifying the machine-readable access control policies by generating and executing test cases against designated test data to confirm compliance with the access policies and the data model specifications, thereby producing verified access control policies. The operations may further include publishing the verified access control policies to one or more implementation layers to produce published access control policies. Finally, the operations may include deploying the published access control policies into a production environment for real-time enforcement of access control rules.

Additional aspects of the subject disclosure may comprise the generative artificial intelligence (AI) module including an integrity check tool configured to analyze the plain English descriptions of access policies to identify ambiguities, inconsistencies, or conflicts in the access control parameters; a test case generation tool configured to generate test cases based on the machine-readable access control policies and the data model specifications, wherein the test cases are used to verify compliance with the access control parameters; and/or a query generation tool configured to produce data layer criteria, such as structured query language (SQL) queries and distributed search engine queries, for enforcing the access control parameters at the data source level.

The operations may further include storing the verified access control policies in a source control system, wherein the source control system manages version control and tracks changes to the machine-readable access control policies; and dynamically updating the machine-readable access control policies in response to changes in the data model specifications by supplying updated data model specifications to the AI module.

One or more aspects of the subject disclosure include a non-transitory machine-readable medium comprising executable instructions that, when executed by a server including a processor, facilitate performance of operations. The operations may include receiving plain English descriptions of access policies for a specified domain, wherein the plain English descriptions define access control parameters for users, roles, and permissions. The operations may further include providing the plain English descriptions to an integrity check AI module configured to analyze the descriptions to identify ambiguities, inconsistencies, or conflicts in the access control parameters. The operations may also include providing the plain English descriptions, along with data model specifications and a structured prompt, to a policy generation AI module. The operations may further include receiving, from the policy generation AI module, machine-readable access control policies generated based on the plain English descriptions and the data model specifications, wherein the machine-readable access control policies specify access control rules for the users, roles, and permissions. Additionally, the operations may include verifying the machine-readable access control policies by interacting with a test case generation AI module to generate test cases and a test data generation AI module to create designated test data.

Additional aspects of the subject disclosure may include the machine-readable access control policies including Rego policies configured for enforcement in a policy management system, Immuta® policies configured for access control in a data lake environment, and/or data layer criteria, including structured query language (SQL) queries and distributed search engine queries, configured for enforcing access control rules at the data source level. Immuta® is a registered trademark of Immuta, Inc.

The operations may further include publishing the verified access control policies to one or more implementation layers to produce published access control policies, and/or deploying the published access control policies into a production environment for real-time enforcement of access control rules.

One or more aspects of the subject disclosure include a method, comprising: receiving, by a processing system including a processor, plain English descriptions of user access policies for a domain, wherein the plain English descriptions define access control rules for users, roles, and permissions within the domain. The method may further include providing, by the processing system, the plain English descriptions along with a structured prompt to a generative artificial intelligence (AI) system. The method may also include receiving, by the processing system, from the generative AI system, extracted actors, actions, and assets from the plain English descriptions. Additionally, the method may include providing, by the processing system, to the generative AI system, data model descriptions that describe the structure, relationships, and attributes of data sources governed by the user access policies. The method may further include receiving, by the processing system, from the generative AI system, machine-readable artifacts generated based on the plain English descriptions and the data model descriptions. The method may also include verifying, by the processing system, the machine-readable artifacts by generating test cases and executing the test cases against test data to ensure compliance with the user access policies and the data model descriptions, thereby producing verified artifacts. The method may further include publishing, by the processing system, the verified artifacts to implementation layers, wherein the implementation layers comprise policy management systems, data lakes, databases, or any combination thereof to produce published artifacts. Finally, the method may include promoting, by the processing system, the published artifacts to a production environment, wherein the published artifacts are deployed for real-time enforcement of the access control parameters.

Additional aspects of the subject disclosure may include the structured prompt specifying standards, formats, and contextual information for generating the machine-readable artifacts; and/or the data model descriptions being obtained by querying a database schema, receiving logical data models, or accessing pre-defined metadata. Further, in some embodiments, the machine-readable artifacts may comprise Rego policies for enforcement in a policy management system, Immuta® policies for data lake access control, or any combination thereof.

In some embodiments, the generative AI system may include an integrity check tool configured to analyze the plain English descriptions to identify ambiguities, inconsistencies, or conflicts in the access control rules; a test case generation tool configured to generate the test cases based on the machine-readable artifacts and the data model descriptions, wherein the test cases are used to verify compliance with the user access policies; a test data generation tool configured to create test data that simulates real-world scenarios for evaluating the machine-readable artifacts against the user access policies and the data model descriptions; and/or a policy publishing tool configured to publish the machine-readable artifacts, including Rego policies, Immuta® policies, or data layer criteria.

### BRIEF DESCRIPTION OF THE DRAWINGS

Reference will now be made to the accompanying drawings, which are not necessarily drawn to scale, and wherein:

FIGS. 1 and FIGS. 2A-2D are block diagrams illustrating example, non-limiting embodiments of systems functioning in accordance with various aspects described herein.

FIG. 3 depicts an illustrative embodiment of a method in accordance with various aspects described herein.

FIG. 4 is a block diagram of an example, non-limiting embodiment of a computing environment in accordance with various aspects described herein.

FIG. 5 is a block diagram of an example, non-limiting embodiment of a mobile network platform in accordance with various aspects described herein.

FIG. 6 is a block diagram of an example, non-limiting embodiment of a mobile network platform in accordance with various aspects described herein.

FIGS. 7-10B depict illustrative embodiments of methods in accordance with various aspects described herein.

### DETAILED DESCRIPTION

The subject disclosure describes, among other things, illustrative embodiments for automating policy management for user entitlements using generative artificial intelligence (AI). In modern computing environments, managing user entitlements is useful for supporting robust security and compliance. Traditional systems often rely on static roles and permissions, which can be inflexible and challenging to update as security requirements evolve. These embodiments address these challenges by leveraging generative AI to automate the creation and management of user entitlements policies.

In some embodiments, the system receives plain English descriptions of user entitlements, which define access control rules for users within a system. These descriptions are processed by a generative AI system to generate a user entitlements policy in a machine-readable format. The policy specifies access control rules that govern what resources users can access and under what conditions. This approach allows for more dynamic and adaptable policy management, reducing the manual effort required to maintain and update access control rules.

The generative AI system may also generate queries, such as structured queries and queries for use in distributed search engines. Examples include, but are not limited to, structured query language (SQL) and Elasticsearch® queries, that are configured to operate in compliance with the user entitlements policy. Elasticsearch® is a registered trademark of Elasticsearch B.V. These queries enforce access control rules at the data layer, supporting the restriction of access to specific data fields or resources to authorized users. By automating the generation of these queries, the system streamlines the process of implementing access control across diverse data sources.

Various embodiments may also integrate the user entitlements policy and queries into a source control system. This system manages version control and tracks changes to the policy and queries, facilitating efficient management and auditing of policy updates. The source control system systematically records all changes, allowing for easy retrieval and review of policy modifications.

Various embodiments may also support dynamic updates to the user entitlements policy in response to changes in data models or access control requirements. For example, if a new role is added to the entitlements policies or a new attribute is introduced in the data model descriptions, the existing policy can be fed back to the AI system as additional context. The AI system then processes this information to generate an updated policy that aligns with the new requirements.

In addition to managing access control for traditional data sources, the user entitlements policy can be applied to various other use cases. For instance, the policy can be integrated with data visualization tools to ensure that users only see data they are authorized to access. It can also be used to control access to cloud-based resources, such as virtual machines and storage buckets, in multi-tenant environments.

The system's ability to generate and enforce access control policies across different platforms and data sources enhances its versatility and adaptability. By leveraging generative AI, various embodiments provide a consistent and robust framework for managing user entitlements, improving security and compliance while reducing the complexity of policy management.

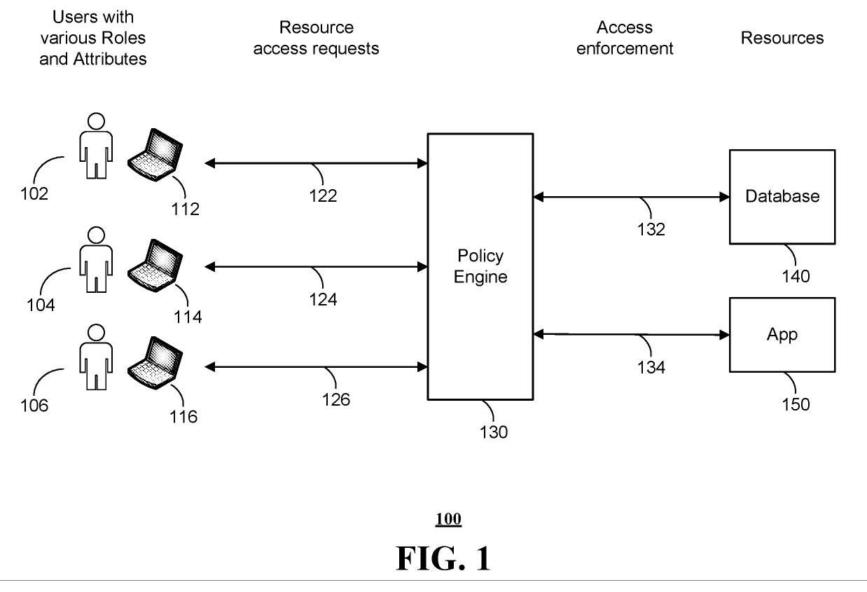

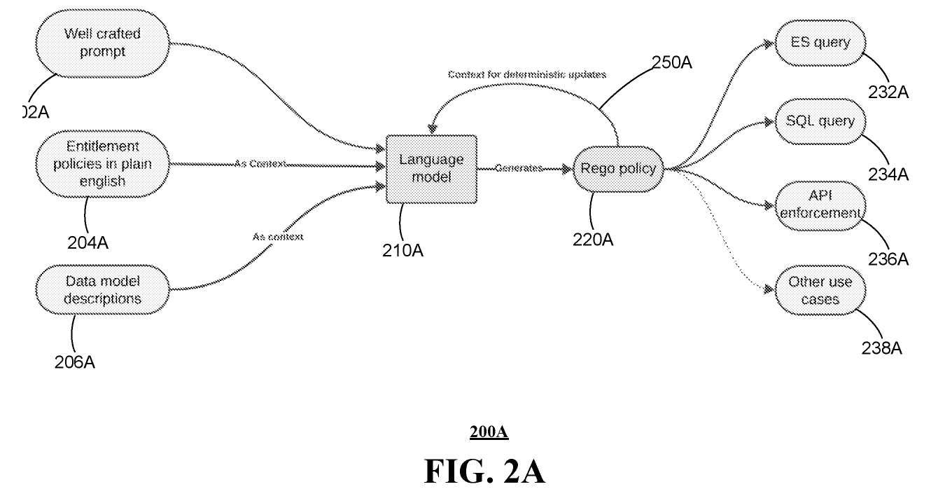

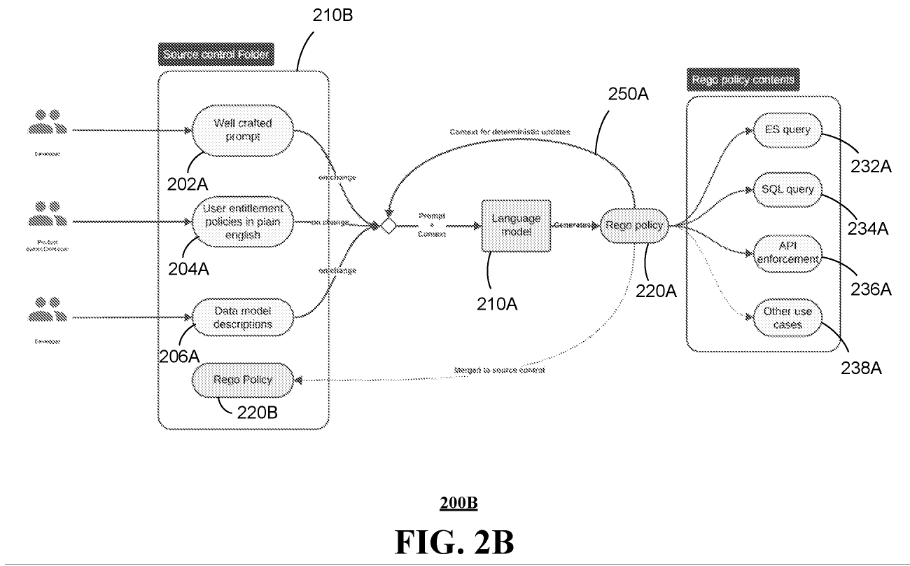

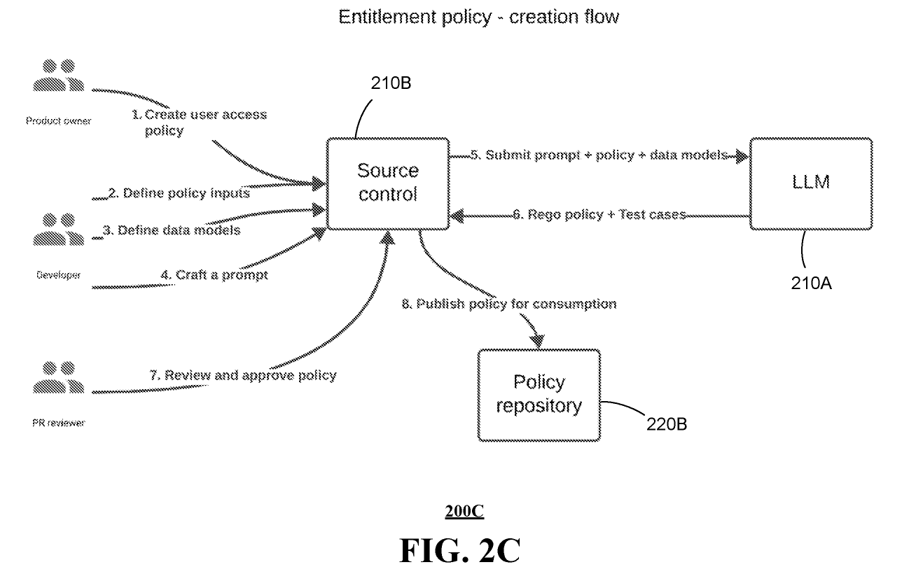

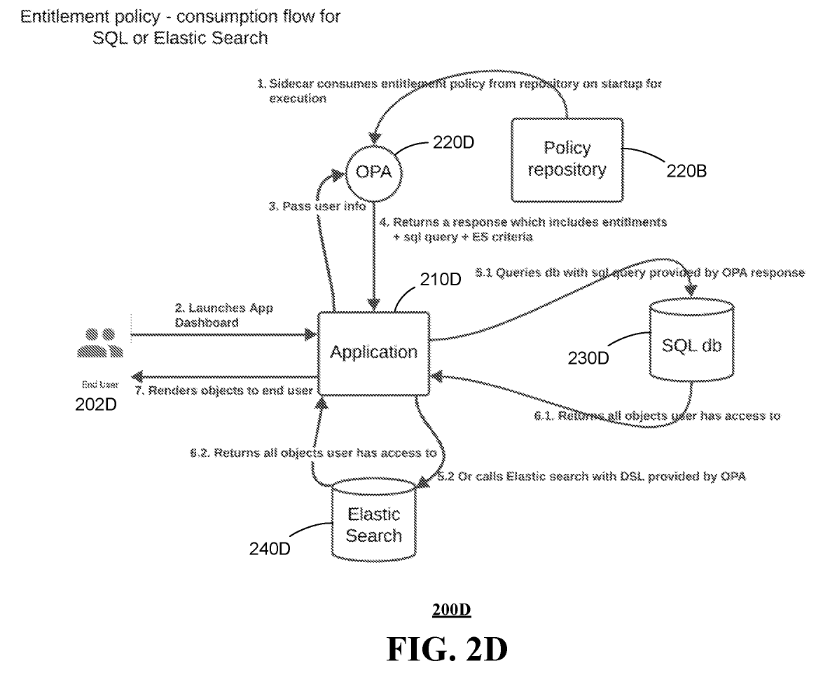

FIGS. 1 and FIGS. 2A-2B are block diagrams illustrating example, non-limiting embodiments of a system functioning in accordance with various aspects described herein.

Referring to FIG. 1, system 100 includes terminals 112, 114, 116; policy engine 130; database 140; and application 150. Users 102, 104, and 106 represent individuals with various roles and attributes, which determine their access rights within system 100. For example, in some embodiments, users may be assigned roles such as "Admin" or "Editor," and attributes like "Department" or "Location." For example, User 102 might have an "Admin" role with access to all resources, while User 104 might have an "Editor" role with limited access.

Terminals 112, 114, and 116 are devices through which users interact with the system. In some embodiments, terminals may include personal computers, tablets, or smartphones. For example, Terminal 112 could be a laptop used by User 102 to access system resources.

The Policy Engine 130 is implemented as a software application responsible for enforcing user entitlements policies. It can be deployed using various policy management systems, such as Open Policy Agent (OPA), which allows it to evaluate access requests based on policies written in Rego or other formats. The deployment of the Policy Engine can be flexible, residing either on dedicated servers or in the cloud, depending on the specific requirements and infrastructure of the organization. This flexibility ensures that the Policy Engine can efficiently manage and enforce access control rules across different environments, providing robust security and compliance.

Resource access requests 122, 124, and 126 are initiated by users through their terminals to access system resources. In some embodiments, these requests are evaluated by the Policy Engine to determine if access should be granted. For example, a request from User 104 to access a database might be allowed if the user's role permits it.

Access enforcement 132 and 134 represent the actions taken by the Policy Engine to grant or deny access to resources. In some embodiments, access enforcement may involve allowing or blocking data retrieval from a database or application. For example, access enforcement 132 might permit User 102 to retrieve data from Database 140.

Database 140 and Application 150 are examples of system resources subject to access control. In some embodiments, these resources may include any type of system, such as cloud services or internal networks. For example, Database 140 could store sensitive company data, while Application 150 might be a software tool used for project management.

In the context of FIG. 1, consider an operation where User 104, who has an "Editor" role and is part of the "Marketing" department, requests access to an application dashboard that displays data from Database 140. The dashboard is designed to show only the data that the user is entitled to access based on their roles and attributes.

User 104 initiates a resource access request through Terminal 114 to view the application dashboard. The request is sent to the Policy Engine 130 for evaluation. The Policy Engine 130, which may be implemented using a policy management system like Open Policy Agent (OPA), evaluates the request against the user entitlements policies. These policies may be written in a format such as Rego and define access control rules based on roles and attributes.

The Policy Engine 130 determines that User 104, with the "Editor" role and "Marketing" department attribute, is allowed to view data related to marketing campaigns but not financial data. The policy specifies that only users with an "Admin" role can access financial data. Based on the evaluation, access enforcement is performed. The Policy Engine 130 allows the application dashboard to query Database 140 for marketing-related data only, filtering out any financial data.

The application dashboard retrieves the permitted data from Database 140 and displays it to User 104 on Terminal 114. The user can now view and interact with the marketing data as allowed by their entitlements. In this example, the Policy Engine 130 effectively enforces access control rules, ensuring that User 104 can only access data they are entitled to, based on their role and department attribute. If User 104 had requested access to financial data, the Policy Engine would have denied the request, preventing unauthorized access.

Referring to FIG. 2A, system 200A includes prompt 202A, entitlements policies in plain English 204A, data model descriptions 206A, AI system 210A, user entitlements policy 220A, Elasticsearch® (ES) query 232A, SQL query 234A, API enforcement 236A, and other use cases 238A.

The prompt 202A is a well-crafted input that guides the AI system in generating the desired outputs. In some embodiments, the prompt may include specific instructions or context to ensure accurate policy generation. For example, the prompt might specify the types of access control rules to be generated. Further, in some embodiments, the prompt may be implemented as a text file stored in a source control system.

Entitlements policies in plain English 204A provide a human-readable description of access control rules. In some embodiments, these policies may outline who can access specific resources based on roles or attributes. For example, a policy might state that only users with an "Admin" role can access financial data. Further, in some embodiments, these policies may be implemented as documents that are reviewed and updated by policy administrators.

Data model descriptions 206A describe the structure of the data sources that the policies will govern. In some embodiments, these descriptions may include information about the fields and relationships within a database. For example, a data model description might specify that a "User" object includes attributes like "role" and "department." Further, in some embodiments, these descriptions may be implemented as schema files that are used to generate queries.

The AI system 210A processes the inputs to generate the user entitlements policy 220A. In some embodiments, the AI system may use machine learning techniques to interpret the prompt, policies, and data models. For example, the AI system might use a language model to convert plain English policies into a machine-readable format. Further, in some embodiments, the AI system may be implemented as a cloud-based service that integrates with other systems.

The user entitlements policy 220A is the output generated by the AI system, specifying access control rules in a machine-readable format. In some embodiments, this policy may include various components such as queries and enforcement mechanisms. For example, the policy might include an ES query 232A, an SQL query 234A, and API enforcement rules 236A. Further, in some embodiments, the policy may be implemented as a configuration file that is deployed to a policy management system.

In some embodiments, the queries 232A (ES query) and 234A (SQL query) are generated as integral components of the user entitlements policy 220A by the AI system 210A. For example, these queries may be formulated based on the entitlements policies in plain English 204A and the data model descriptions 206A.

In some embodiments, the AI system interprets the access control rules defined in the entitlements policies 204A to determine the conditions under which users can access specific resources. For example, a policy might specify that only users with a certain role can access particular data fields. The AI system uses this information to construct queries that enforce these rules at the data layer.

The data model descriptions 206A provide the structural context necessary for generating accurate queries. They describe the organization and relationships of data within the system, such as tables, fields, and indices. For example, a data model description might indicate that a "User" object includes attributes like "role" and "department," which are used for formulating queries that align with the access control rules. The AI system can generate queries that apply the same access control logic as the user entitlement policies, allowing for consistent enforcement across different data sources. This capability reduces the need for maintaining separate logic in multiple places, streamlining the process and minimizing potential errors.

In some embodiments, the AI system generates the ES query 232A and SQL query 234A by translating the access control rules and data model descriptions into the respective query languages. For example, the AI system might generate an SQL query that includes a WHERE clause to filter data based on user roles, or an Elasticsearch® query that uses a “term” filter to restrict access to specific document fields. These queries are then incorporated into the user entitlements policy 220A, enabling the system to enforce access control directly at the data source level.

In some embodiments, API enforcement rules 236A are designed to govern how APIs interact with system resources, ensuring that only authorized users can access or manipulate data through these interfaces. These rules are formulated based on the user entitlements policies in plain English 204A and the data model descriptions 206A, which provide the necessary context for defining access control conditions.

For example, API enforcement rules might specify that only users with an "Admin" role can perform certain actions, such as creating or deleting records, while users with an "Editor" role may only update existing records. These rules ensure that the API operations are aligned with the organization's security policies and access control requirements.

Further, in some embodiments, API enforcement rules 236A may be implemented as part of a configuration file that is deployed to a policy management system, such as Open Policy Agent (OPA). This deployment allows for centralized management and consistent enforcement of access control policies across all APIs within the system. The configuration file may include detailed specifications of the API endpoints, the required authentication and authorization mechanisms, and the conditions under which access is granted or denied.

By incorporating API enforcement rules into the user entitlements policy, the system can effectively manage access to resources through APIs, ensuring that security and compliance requirements are met while providing flexibility to adapt to changing business needs. This approach enhances the overall security posture of the system by reducing the risk of unauthorized access and ensuring that all API interactions are subject to the same rigorous access control standards.

The component labeled as "other use cases" 238A in FIG. 2A represents additional scenarios where the user entitlements policy 220A can be applied beyond the primary examples of Elasticsearch® queries, SQL queries, and API enforcement. These use cases highlight the versatility and adaptability of the user entitlements policy in various contexts, enhancing security and operational efficiency across different systems.

One example of another use case is in the realm of data analytics and reporting. The user entitlements policy can be integrated with data visualization tools to ensure that users only see data they are authorized to access. For instance, in a business intelligence dashboard, the policy can dynamically filter data sets based on user roles and attributes, ensuring compliance with data governance standards while providing users with relevant insights. This integration can prevent unauthorized data exposure and maintain data privacy across the organization.

Another example is in the context of cloud resource management. The user entitlements policy can be used to control access to cloud-based resources, such as virtual machines, storage buckets, and network configurations. By applying the policy, organizations can enforce fine-grained access controls, ensuring that only authorized personnel can modify or deploy cloud resources. This use case is particularly beneficial in multi-tenant environments where different teams or departments require varying levels of access to shared cloud infrastructure.

These examples demonstrate how the user entitlements policy can be extended to various domains, providing a consistent and robust framework for managing access control across diverse applications and systems. By leveraging the policy in these additional use cases, organizations can enhance their security posture and ensure compliance with regulatory requirements while maintaining operational flexibility.

Operation 250A involves providing the existing user entitlements policy to the AI system as context for generating updates. In some embodiments, when components such as 204A (entitlements policies in plain English) or 206A (data model descriptions) are updated, the user entitlements policy may also need to be revised to reflect these changes. For example, if a new role is added to the entitlements policies or a new attribute is introduced in the data model descriptions, the existing user entitlements policy is fed back to the AI system as additional context. This feedback loop allows the AI system to consider the current policy framework while generating an updated policy. The AI system then processes this information, along with the updated inputs, to produce a revised user entitlements policy that aligns with the new requirements. This iterative process ensures that the policy remains accurate and relevant, adapting to changes in roles, attributes, or data structures.

In some embodiments, certain AI/ML models can be selected based on the type of queries that are to be generated. For example, one type of AI/ML model can be used to generate Elasticsearch® (ES) queries, while another type can be employed to generate SQL queries. This approach allows for the optimization of query generation by leveraging models that are specifically trained or designed to handle the syntax and semantics of different query languages. By selecting appropriate models for each query type, the system can ensure more accurate and efficient query generation, aligning with the specific requirements of the data sources and access control rules.

In some embodiments, the generative AI system can be configured to provide queries that improve processor utilization when searching a database by optimizing the structure and execution of these queries. This optimization can be achieved by leveraging machine learning techniques to analyze historical query performance data and identify patterns that lead to efficient processor usage. The AI system can then generate queries that minimize computational overhead by selecting the most efficient query paths, reducing the number of unnecessary operations, and prioritizing the retrieval of relevant data. Additionally, the AI system can incorporate indexing strategies and caching mechanisms to further enhance query performance, ensuring that frequently accessed data is readily available and reducing the need for repetitive processing.

In some embodiments, this is accomplished by the AI system being trained on a dataset that includes various query types and their corresponding performance metrics. By understanding the relationship between query structure and processor utilization, the AI system can learn to predict the impact of different query configurations on system resources. This predictive capability allows the AI system to generate queries that are not only compliant with the user entitlements policy but also optimized for efficient execution. Furthermore, the AI system can continuously refine its query generation algorithms by incorporating feedback from real-time query performance, enabling it to adapt to changing database structures and usage patterns.

Referring to FIG. 2B, a system 200B for generating and managing user entitlements policies is illustrated, with a focus on the source control aspects represented by components 210B and 220B. The Source Control Folder 210B acts as a centralized repository for managing artifacts related to policy generation, including the well-crafted prompt 202A, entitlements policies in plain English 204A, and data model descriptions 206A. This system ensures that all changes to these components are tracked and version-controlled, facilitating efficient management and auditing of policy updates.

The User Entitlements Policy 220B is the output generated by the AI system 210A, specifying access control rules in a machine-readable format. This policy is stored within the Source Control Folder 210B, ensuring that it is version-controlled and can be updated as necessary. The policy includes various components such as queries and enforcement mechanisms, which are implemented as configuration files deployed to a policy management system.

Consider an example where a developer modifies a field in a database as represented by the data model descriptions 206A. This change is committed to the Source Control Folder 210B, triggering an automated process that submits the updated data model descriptions to the AI system 210A. The AI system processes the updated information, along with the existing user entitlements policies and prompts, to generate a revised user entitlements policy 220B that reflects the changes in the database field.

The updated policy also results in modifications to the queries, such as the ES query 232A and SQL query 234A, to ensure they accurately access the modified field in the database. Once the updated policy and queries are generated, they are recommitted to the Source Control Folder 210B, ensuring that the latest versions are available for deployment and enforcement. This process exemplifies how the system dynamically adapts to changes in data models, ensuring that access control policies and queries remain accurate and relevant. By leveraging the source control system, the organization can maintain a robust and flexible policy management framework that supports evolving security requirements and business needs.

Referring to FIG. 2C, system 200C shows a flow for the creation of an entitlement policy, highlighting the interactions between various components involved in the process. The figure includes components such as the Source Control 210B, AI System 210A, and the Policy Repository 220B, along with example roles of the Product Owner, Developer, and Reviewer.

The process begins with the Product Owner creating a user access policy, which serves as the foundational input for defining access control rules. This policy is then provided to the Source Control 210B. Next, the Developer defines policy inputs, which may include specific conditions or parameters that influence how the access control rules are applied. In some embodiments, these inputs are also stored in the Source Control 210B.

Following this, the Developer defines data models that describe the structure and relationships of the data sources governed by the policies. These models are useful for ensuring that the generated policies align with the underlying data architecture. The Developer also crafts a prompt, which is a well-structured input that guides the AI System 210A in generating the desired policy outputs.

Once these inputs are prepared, the Source Control 210B submits the prompt, policy, and data models to the AI System 210A. The AI System processes these inputs to generate a user entitlements policy and associated test cases, which are then returned to the Source Control 210B. The test cases are designed to verify the accuracy and compliance of the generated policy.

Optionally, a Reviewer may review and approve the policy to ensure it meets organizational standards and requirements. This step adds an additional layer of validation to the process, allowing for human oversight and quality assurance.

Finally, the Source Control 210B publishes the policy for consumption, making it available for deployment and enforcement within the system. This flow ensures that the entitlement policy is created in a structured and controlled manner, leveraging both automated and manual processes to achieve a robust and reliable access control framework.

Referring to FIG. 2D, system 200D illustrates the flow for the consumption of the entitlement policy within the context of a dashboard application. This figure highlights the interactions between various components as the entitlement policy is applied to manage user access to system resources.

The process begins with the Policy Engine 220D consuming the entitlement policy from the Policy Repository 220B upon startup for execution. This step ensures that the most current policy is loaded and ready to enforce access control rules.

Next, the End User 202D launches the dashboard application 210D. The Application 210D, upon receiving the user's request, passes the user information to the Policy Engine 220D. This information is used to evaluate the user's entitlements based on the loaded policy.

The Policy Engine 220D returns a response to the Application 210D, which includes the user's entitlements, an SQL query, and/or Elasticsearch® (ES) criteria. These elements are used to determine what data the user is authorized to access.

The Application 210D then queries the Database 230D using the SQL query provided in the response. Simultaneously, or alternatively, the Application 210D may call Elasticsearch® 240D with the DSL provided by the Policy Engine 220D. The execution of these queries depends on the data sources involved and the specific requirements of the dashboard application.

If the SQL query is executed, the Database 230D returns all objects that the user has access to. Similarly, if the Elasticsearch® query is executed, Elasticsearch® 240D returns all objects that the user is entitled to access. These steps ensure that the user only receives data they are authorized to view, based on their entitlements.

Finally, the Application 210D renders the retrieved objects to the End User 202D, displaying the data on the dashboard. This flow demonstrates how the entitlement policy is applied in real-time to manage user access, ensuring compliance with access control rules and maintaining data security within the system.

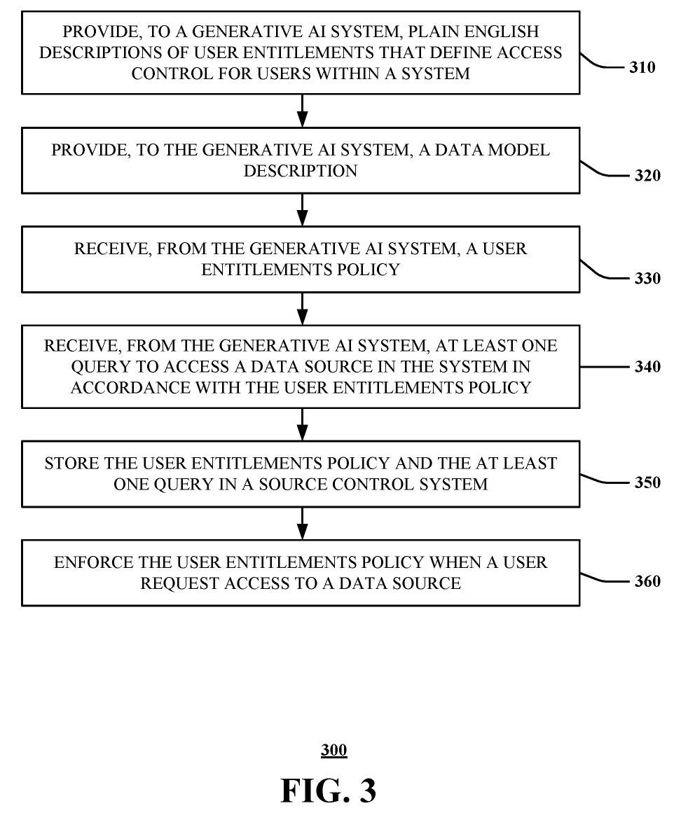

FIG. 3 depicts an illustrative embodiment of a method in accordance with various aspects described herein. This method 300 involves several components from previous figures, such as the AI system 210A, Source Control 210B, and Policy Repository 220B, which may perform the actions described in the blocks.

At block 310, "Provide, to a generative AI system, plain English descriptions of user entitlements that define access control for users within a system," the process begins by supplying the AI system 210A with human-readable descriptions of access control rules. In some embodiments, this step involves using the entitlements policies in plain English 204A, as shown in FIG. 2A, to ensure that the AI system has the necessary context to generate accurate policies.

At block 320, "Provide, to the generative AI system, a data model description," the data model descriptions 206A are supplied to the AI system 210A. These descriptions outline the structure of the data sources governed by the policies. In some embodiments, this step ensures that the AI system can generate queries that align with the data architecture, as depicted in FIG. 2A.

At block 330, "Receive, from the generative AI system, a user entitlements policy," the AI system 210A generates a machine-readable policy based on the provided inputs. This policy, which may be stored in the Source Control 210B as shown in FIG. 2B, specifies the access control rules for users within the system.

At block 340, "Receive, from the generative AI system, at least one query to access a data source in the system in accordance with the user entitlements policy," the AI system 210A generates queries, such as ES query 232A and SQL query 234A, that enforce the access control rules at the data layer. These queries are integral to the user entitlements policy 220A, as illustrated in FIG. 2A. The actions of block 340 are not required. For example, user entitlement policies written in languages such as Rego may be designed to evaluate input and respond with one or more output variables, which may or may not include a well-formed SQL query for direct application in the data layer. While this is included in some embodiments, it is not mandatory. Also for example, when applied to REST APIs for accessing or acting on a specific object, Rego may return only the actions that a user is permitted to perform on that object, without running a complex query against the database. The capability to generate a query as Rego output may be introduced only when the experience layer/UI requests information on all objects a user can access and the actions they can perform. This approach allows the entitled user to apply their entitlements directly in the data layer, as iterating over all objects and generating user entitlements for each would be a compute and memory-intensive operation.

At block 350, "Store the user entitlements policy and the at least one query in a source control system," the generated policy and queries are stored in the Source Control 210B. This step ensures that all changes are tracked and version-controlled, facilitating efficient management and auditing of policy updates, as shown in FIG. 2B.

At block 360, "Enforce the user entitlements policy when a user requests access to a data source," the policy is applied in real-time to manage user access. In some embodiments, this involves the Policy Engine 220D consuming the policy from the Policy Repository 220B, as depicted in FIG. 2D, to ensure compliance with access control rules and maintain data security within the system.

While for purposes of simplicity of explanation, the respective processes are shown and described as a series of blocks in FIG. 3, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein. Note, one or more blocks can be performed in response to one or more other blocks.

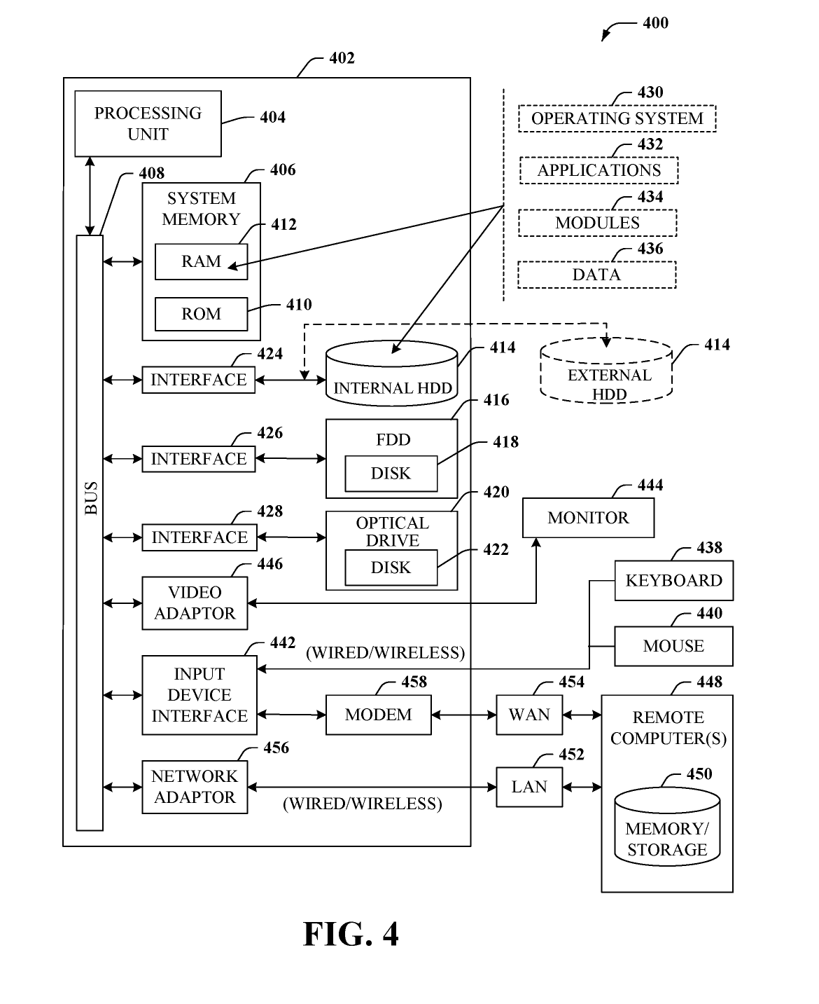

Turning now to FIG. 4, there is illustrated a block diagram of a computing environment in accordance with various aspects described herein. In order to provide additional context for various embodiments of the embodiments described herein, FIG. 4 and the following discussion are intended to provide a brief, general description of a suitable computing environment 400 in which the various embodiments of the subject disclosure can be implemented. In particular, the computing environment 400 can be used in computing device described herein. Each of these devices can be implemented via computer-executable instructions that can run on one or more computers, and/or in combination with other program modules and/or as a combination of hardware and software. For example, computing environment 400 can facilitate in whole or in part the automation of policy management for user entitlements by leveraging a generative AI system to convert plain English descriptions into machine-readable policies. This environment supports the generation of access control rules, the creation of queries for data sources, and the integration of these elements into a policy management system, thereby enhancing security and compliance across diverse computing systems.

Generally, program modules comprise routines, programs, components, data structures, etc., that perform particular tasks or implement particular abstract data types. Moreover, those skilled in the art will appreciate that the methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that while any functions and features described herein in association with the operation of a processor could likewise be performed by a processing circuit.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can comprise, but are not limited to, random access memory (RAM), read only memory (ROM), electrically erasable programmable read only memory (EEPROM),flash memory or other memory technology, compact disk read only memory (CD-ROM), digital versatile disk (DVD) or other optical disk storage, magnetic cassettes, magnetic tape, magnetic disk storage or other magnetic storage devices or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 4, the example environment can comprise a computer 402, the computer 402 comprising a processing unit 404, a system memory 406 and a system bus 408. The system bus 408 couples system components including, but not limited to, the system memory 406 to the processing unit 404. The processing unit 404 can be any of various commercially available processors. Dual microprocessors and other multiprocessor architectures can also be employed as the processing unit 404.

The system bus 408 can be any of several types of bus structure that can further interconnect to a memory bus (with or without a memory controller), a peripheral bus, and a local bus using any of a variety of commercially available bus architectures. The system memory 406 comprises ROM 410 and RAM 412. A basic input/output system (BIOS) can be stored in a non-volatile memory such as ROM, erasable programmable read only memory (EPROM), EEPROM, which BIOS contains the basic routines that help to transfer information between elements within the computer 402, such as during startup. The RAM 412 can also comprise a high-speed RAM such as static RAM for caching data.

The computer 402 further comprises an internal hard disk drive (HDD) 414 (e.g., EIDE, SATA), which internal HDD 414 can also be configured for external use in a suitable chassis (not shown), a magnetic floppy disk drive (FDD) 416, (e.g., to read from or write to a removable diskette 418) and an optical disk drive 420, (e.g., reading a CD-ROM disk 422 or, to read from or write to other high-capacity optical media such as the DVD). The HDD 414, magnetic FDD 416 and optical disk drive 420 can be connected to the system bus 408 by a hard disk drive interface 424, a magnetic disk drive interface 426 and an optical drive interface 428, respectively. The hard disk drive interface 424 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 402, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 412, comprising an operating system 430, one or more application programs 432, other program modules 434 and program data 436. All or portions of the operating system, applications, modules, and/or data can also be cached in the RAM 412. The systems and methods described herein can be implemented utilizing various commercially available operating systems or combinations of operating systems.

A user can enter commands and information into the computer 402 through one or more wired/wireless input devices, e.g., a keyboard 438 and a pointing device, such as a mouse 440. Other input devices (not shown) can comprise a microphone, an infrared (IR) remote control, a joystick, a game pad, a stylus pen, touch screen or the like. These and other input devices are often connected to the processing unit 404 through an input device interface 442 that can be coupled to the system bus 408, but can be connected by other interfaces, such as a parallel port, an IEEE 1394 serial port, a game port, a universal serial bus (USB) port, an IR interface, etc.

A monitor 444 or other type of display device can be also connected to the system bus 408 via an interface, such as a video adapter 446. It will also be appreciated that in alternative embodiments, a monitor 444 can also be any display device (e.g., another computer having a display, a smart phone, a tablet computer, etc.) for receiving display information associated with computer 402 via any communication means, including via the Internet and cloud-based networks. In addition to the monitor 444, a computer typically comprises other peripheral output devices (not shown), such as speakers, printers, etc.

The computer 402 can operate in a networked environment using logical connections via wired and/or wireless communications to one or more remote computers, such as a remote computer(s) 448. The remote computer(s) 448 can be a workstation, a server computer, a router, a personal computer, portable computer, microprocessor-based entertainment appliance, a peer device or other common network node, and typically comprises many or all of the elements described relative to the computer 402, although, for purposes of brevity, only a remote memory/storage device 450 is illustrated. The logical connections depicted comprise wired/wireless connectivity to a local area network (LAN) 452 and/or larger networks, e.g., a wide area network (WAN) 454. Such LAN and WAN networking environments are commonplace in offices and companies, and facilitate enterprise-wide computer networks, such as intranets, all of which can connect to a global communications network, e.g., the Internet.

When used in a LAN networking environment, the computer 402 can be connected to the LAN 452 through a wired and/or wireless communication network interface or adapter 456. The adapter 456 can facilitate wired or wireless communication to the LAN 452, which can also comprise a wireless AP disposed thereon for communicating with the adapter 456.

When used in a WAN networking environment, the computer 402 can comprise a modem 458 or can be connected to a communications server on the WAN 454 or has other means for establishing communications over the WAN 454, such as by way of the Internet. The modem 458, which can be internal or external and a wired or wireless device, can be connected to the system bus 408 via the input device interface 442. In a networked environment, program modules depicted relative to the computer 402 or portions thereof, can be stored in the remote memory/storage device 450. It will be appreciated that the network connections shown are example and other means of establishing a communications link between the computers can be used.

The computer 402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands for example or with products that contain both bands (dual band), so the networks can provide real-world performance similar to the basic 10BaseT wired Ethernet networks used in many offices.

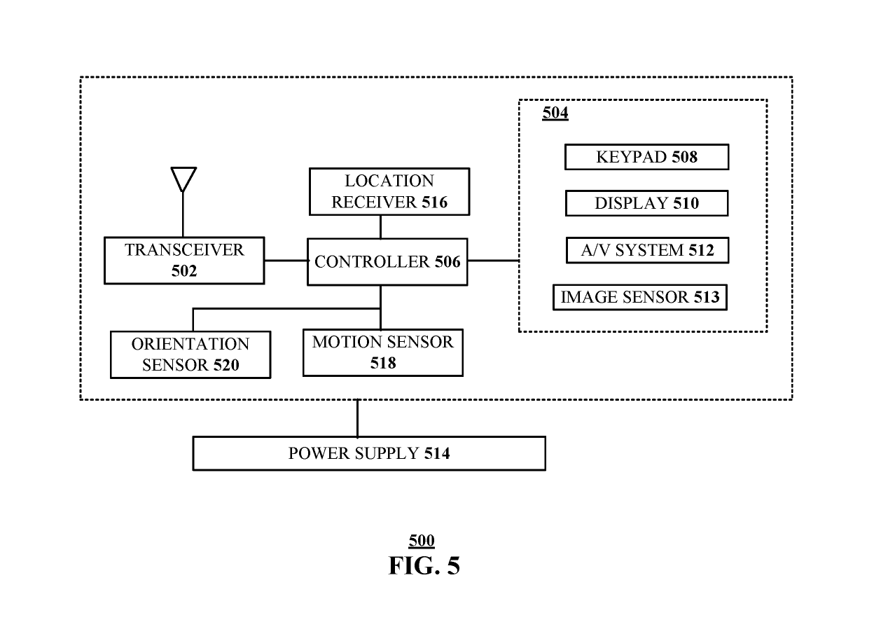

Turning now to FIG. 5, an illustrative embodiment of a communication device 500 is shown. Communication device 500 can facilitate in whole or in part the interaction between a user and a system by serving as a terminal through which the user submits access requests. This device enables users to communicate with the policy management system, allowing the enforcement of user entitlements policies and ensuring that access control rules are applied consistently across the system.

The communication device 500 can comprise a wireline and/or wireless transceiver 502 (herein transceiver 502), a user interface (UI) 504, a power supply 514, a location receiver 516, a motion sensor 518, an orientation sensor 520, and a controller 506 for managing operations thereof. The transceiver 502 can support short-range or long-range wireless access technologies such as Bluetooth^{®}, ZigBee^{®}, Wi-Fi, DECT, or cellular communication technologies, just to mention a few (Bluetooth^{®} and ZigBee^{®} are trademarks registered by the Bluetooth^{®} Special Interest Group and the ZigBee^{®} Alliance, respectively). Cellular technologies can include, for example, CDMA-1X, UMTS/HSDPA, GSM/GPRS, TDMA/EDGE, EV/DO, WiMAX, SDR, LTE, as well as other next generation wireless communication technologies as they arise. The transceiver 502 can also be adapted to support circuit-switched wireline access technologies (such as PSTN), packet-switched wireline access technologies (such as TCP/IP, VoIP, etc.), and combinations thereof.

The UI 504 can include a depressible or touch-sensitive keypad 508 with a navigation mechanism such as a roller ball, a joystick, a mouse, or a navigation disk for manipulating operations of the communication device 500. The keypad 508 can be an integral part of a housing assembly of the communication device 500 or an independent device operably coupled thereto by a tethered wireline interface (such as a USB cable) or a wireless interface supporting for example Bluetooth^{®}. The keypad 508 can represent a numeric keypad commonly used by phones, and/or a QWERTY keypad with alphanumeric keys. The UI 504 can further include a display 510 such as monochrome or color LCD (Liquid Crystal Display), OLED (Organic Light Emitting Diode) or other suitable display technology for conveying images to an end user of the communication device 500. In an embodiment where the display 510 is touch-sensitive, a portion or all of the keypad 508 can be presented by way of the display 510 with navigation features.

The display 510 can use touch screen technology to also serve as a user interface for detecting user input. As a touch screen display, the communication device 500 can be adapted to present a user interface having graphical user interface (GUI) elements that can be selected by a user with a touch of a finger. The display 510 can be equipped with capacitive, resistive or other forms of sensing technology to detect how much surface area of a user’s finger has been placed on a portion of the touch screen display. This sensing information can be used to control the manipulation of the GUI elements or other functions of the user interface. The display 510 can be an integral part of the housing assembly of the communication device 500 or an independent device communicatively coupled thereto by a tethered wireline interface (such as a cable) or a wireless interface.

The UI 504 can also include an audio system 512 that utilizes audio technology for conveying low volume audio (such as audio heard in proximity of a human ear) and high-volume audio (such as speakerphone for hands free operation). The audio system 512 can further include a microphone for receiving audible signals of an end user. The audio system 512 can also be used for voice recognition applications. The UI 504 can further include an image sensor 513 such as a charged coupled device (CCD) camera for capturing still or moving images.

The power supply 514 can utilize common power management technologies such as replaceable and rechargeable batteries, supply regulation technologies, and/or charging system technologies for supplying energy to the components of the communication device 500 to facilitate long-range or short-range portable communications. Alternatively, or in combination, the charging system can utilize external power sources such as DC power supplied over a physical interface such as a USB port or other suitable tethering technologies.

The location receiver 516 can utilize location technology such as a global positioning system (GPS) receiver capable of assisted GPS for identifying a location of the communication device 500 based on signals generated by a constellation of GPS satellites, which can be used for facilitating location services such as navigation. The motion sensor 518 can utilize motion sensing technology such as an accelerometer, a gyroscope, or other suitable motion sensing technology to detect motion of the communication device 500 in three-dimensional space. The orientation sensor 520 can utilize orientation sensing technology such as a magnetometer to detect the orientation of the communication device 500 (north, south, west, and east, as well as combined orientations in degrees, minutes, or other suitable orientation metrics).

The communication device 500 can use the transceiver 502 to also determine a proximity to a cellular, Wi-Fi, Bluetooth^{®}, or other wireless access points by sensing techniques such as utilizing a received signal strength indicator (RSSI) and/or signal time of arrival (TOA) or time of flight (TOF) measurements. The controller 506 can utilize computing technologies such as a microprocessor, a digital signal processor (DSP), programmable gate arrays, application specific integrated circuits, and/or a video processor with associated storage memory such as Flash, ROM, RAM, SRAM, DRAM or other storage technologies for executing computer instructions, controlling, and processing data supplied by the aforementioned components of the communication device 500.

Other components not shown in FIG. 5 can be used in one or more embodiments of the subject disclosure. For instance, the communication device 500 can include a slot for adding or removing an identity module such as a Subscriber Identity Module (SIM) card or Universal Integrated Circuit Card (UICC). SIM or UICC cards can be used for identifying subscriber services, executing programs, storing subscriber data, and so on.

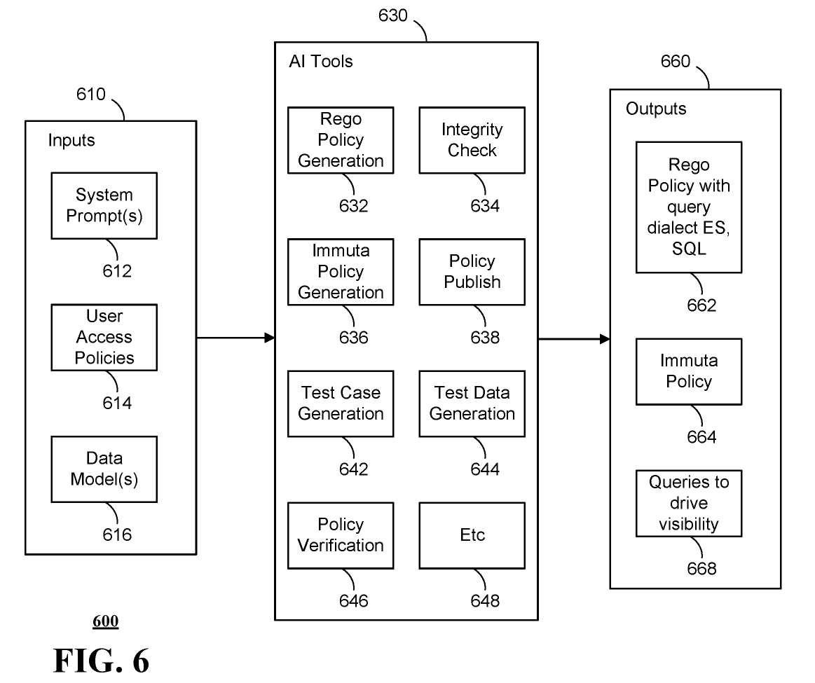

FIG. 6 is a block diagram of an example, non-limiting embodiment of a mobile network platform in accordance with various aspects described herein. FIG. 6 illustrates an example system 600 for automating policy management for user entitlements, including inputs, AI tools, and outputs. The system includes inputs 610, AI tools 630, and outputs 660.

In some embodiments, inputs 610 may include system prompts 612, user access policies 614, and data models 616. System prompts 612 may be predefined structured prompts that guide the AI tools 630 in generating access control policies, specifying standards, formats, and contextual information to ensure alignment with organizational requirements and regulatory standards. For example, a prompt in system prompts 612 may instruct the AI system to prioritize certain roles or permissions based on compliance needs. User access policies 614 may be plain English descriptions of access policies for a specified domain, defining access control parameters such as users, roles, and permissions. For example, a policy in user access policies 614 may state that only users with an "Admin" role can access financial data. Data models 616 may describe the structure, relationships, and attributes of data sources governed by the access policies. These models may be obtained by querying a database schema, receiving logical data models, or accessing pre-defined metadata. For example, a data model in data models 616 may specify that a "User" object includes attributes like "role" and "department."

In some embodiments, AI tools 630 may process the inputs 610 to generate, verify, and publish machine-readable access control policies. For example, a Rego Policy Generation AI Module 632 may generate Rego policies for enforcement in a policy management system, defining access control rules in a machine-readable format. An Integrity Check AI Module 634 may analyze the plain English descriptions in user access policies 614 to identify ambiguities, inconsistencies, or conflicts in the access control parameters. For example, Integrity Check AI Module 634 may flag conflicting rules where one policy grants access while another denies it. An Immuta® Policy Generation AI Module 636 may generate Immuta® policies for access control in a data lake environment, tailored to manage access to large-scale, distributed data sources while ensuring compliance with governance requirements. A Policy Publish AI Module 638 may publish the verified machine-readable artifacts, including Rego policies, Immuta® policies, and data layer criteria, to implementation layers such as policy management systems, data lakes, and databases. A Test Case Generation AI Module 642 may generate test cases based on the machine-readable artifacts and the data model descriptions in data models 616, ensuring compliance with the user access policies 614 and verifying that the generated policies function as intended. A Test Data Generation AI Module 644 may create test data that simulates real-world scenarios for evaluating the machine-readable artifacts. For example, Test Data Generation AI Module 644 may generate synthetic data that mimics actual user behavior while preserving data privacy. A Policy Verification AI Module 646 may verify the machine-readable artifacts by executing the test cases generated by Test Case Generation AI Module 642 against the test data created by Test Data Generation AI Module 644, ensuring compliance with the user access policies 614 and the data model descriptions in data models 616. Additional AI tools 648 may also be included to support other functionalities, such as advanced analytics or reporting.

As used herein, the term “Immuta® policy” refers to a machine-readable access control policy designed to manage and enforce fine-grained access control in data lake environments. Immuta® policies define rules that govern how users, roles, and permissions interact with large-scale, distributed data sources, ensuring compliance with data governance standards and regulatory requirements. For example, in a system that uses a data lake to store sensitive financial data, an Immuta® policy may specify that only users with a "Finance Analyst" role can access transaction records, and even then, only anonymized data fields may be visible unless the user has additional clearance. Such policies are dynamically enforced to adapt to changing user roles, permissions, and data attributes. While Immuta® policies are specifically tailored for use in Immuta®-enabled systems, any type of similar system that requires fine-grained access control for large-scale data environments may be employed. The various embodiments described herein are not limited to Immuta® policies and may include other access control mechanisms or frameworks that achieve similar functionality.

In some embodiments, outputs 660 may include Rego policies with query dialects such as Elasticsearch (ES) and SQL, represented as Rego Policy with Query Dialect ES, SQL 662. These policies enforce access control rules at the data source level to ensure that only authorized users can access specific data fields or resources. Immuta® policies 664 may also be generated for access control in a data lake environment, enabling fine-grained access control while maintaining compliance with data governance standards. Additionally, the system may generate queries to drive visibility 668, providing insights into who has access to specific data at any given time. For example, queries to drive visibility 668 may generate reports showing which users have access to sensitive data fields, offering a holistic view of entitlements for auditing and compliance purposes.

In some embodiments, the system 600 operates by processing the inputs 610 through the AI tools 630 to produce the outputs 660. For example, plain English descriptions in user access policies 614 and data models 616 may be transmitted to the appropriate AI modules, such as Rego Policy Generation AI Module 632 or Immuta® Policy Generation AI Module 636. Integrity Check AI Module 634 may analyze the inputs 610 to identify ambiguities or conflicts, ensuring that the policies generated are accurate and consistent. Test Case Generation AI Module 642 and Test Data Generation AI Module 644 may work together to verify the generated policies by simulating real-world scenarios and executing test cases. Once verified, Policy Publish AI Module 638 may publish the policies to the appropriate implementation layers, such as policy management systems or data lakes. The outputs 660, including Rego Policy with Query Dialect ES, SQL 662, Immuta® Policy 664, and queries to drive visibility 668, may then be deployed for real-time enforcement of access control rules and integrated into a source control system for version management and auditing.

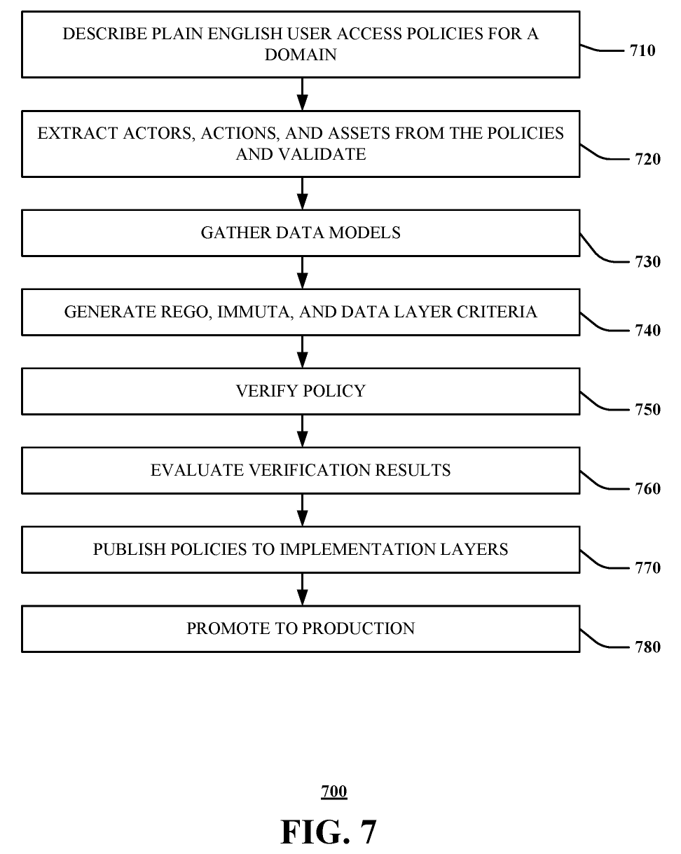

FIGS. 7-10B depict illustrative embodiments of methods in accordance with various aspects described herein.

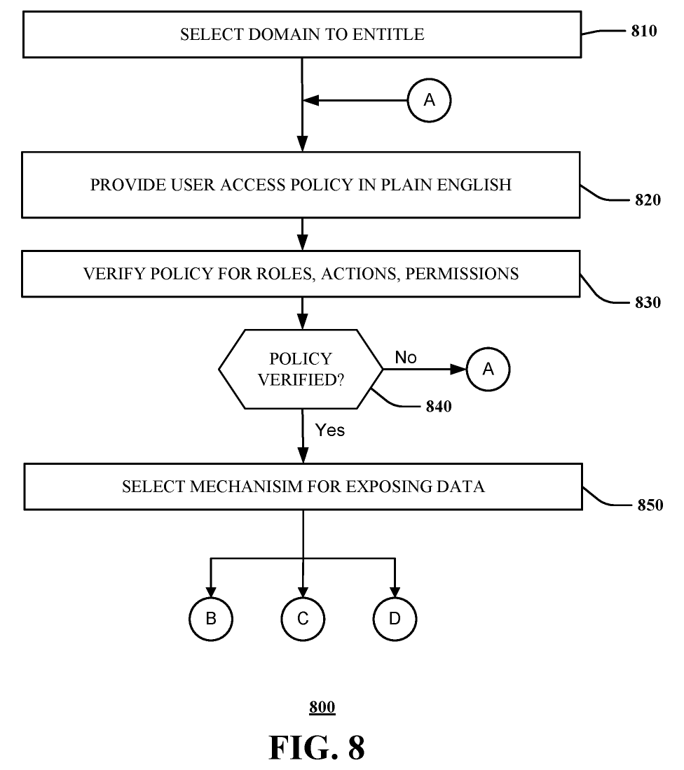

FIG. 7 depicts an illustrative embodiment of a method 700 for automating policy management for user entitlements, providing a high-level overview of the system's operation as described in FIG. 6. Each action in FIG. 7 is described in more detail with reference to FIGS. 8-10B. In some embodiments, the method 700 may be performed by a processing system, a server, or any other system capable of executing the described operations.

At block 710, the method involves describing plain English user access policies for a domain. In some embodiments, this step includes receiving human-readable descriptions of access control rules that define parameters for users, roles, and permissions. For example, a policy may specify that only users with a "Manager" role can access certain financial reports. This step provides the foundational input for generating machine-readable policies. The process performing this operation may include a user interface (UI) component, such as a text input field, where users can enter the plain English descriptions. The process may then interact with an Integrity Check AI Module via an API to analyze the descriptions for ambiguities, inconsistencies, or conflicts. For example, the API may return a report identifying issues in the descriptions, which the UI can display to the user for review and correction. In some embodiments, when ambiguities, inconsistencies, or conflicts are identified, the Integrity Check AI Module or other AI module may suggest corrective actions to resolve any identified ambiguities, inconsistencies, or conflicts. Also for example, any identified ambiguities, inconsistencies, or conflicts may be presented to a user via a user interface to allow the use to provide any corrective actions.

At block 720, the method involves extracting actors, actions, and assets from the policies and validating them. In some embodiments, this step includes analyzing the plain English descriptions to identify key components, such as user roles, permitted actions, and associated resources. For example, the system may extract a "Finance Analyst" role, the action "view," and the asset "transaction records." The extracted components are validated for completeness and consistency, and ambiguities or conflicts are flagged for resolution. The process may interact with the Integrity Check AI Module via an API to perform this operation. For example, the API may accept the plain English descriptions as input and return the extracted components, which the process can validate and display to the user through an interactive table in the UI.

At block 730, the method involves gathering data models. In some embodiments, this step includes obtaining data model descriptions that detail the structure, relationships, and attributes of data sources governed by the access policies. The data models may reflect one or more domains by representing the specific entities, attributes, and relationships that are relevant to the operational environment where the access control rules are applied. For example, in a financial domain, the data model may include entities such as "Accounts," "Transactions," and "Users," with attributes like "Account Balance," "Transaction Amount," and "User Role." Relationships between these entities may specify that a "User" can initiate a "Transaction" on an "Account" if certain conditions are met, such as having an "Admin" or "Finance Analyst" role.

In another example, in a healthcare domain, the data model may include entities such as "Patients," "Medical Records," and "Healthcare Providers," with attributes like "Patient ID," "Record Type," and "Provider Specialty." Relationships may define that a "Healthcare Provider" can access a "Medical Record" only if they are assigned to the corresponding "Patient" and have the appropriate permissions, such as being the primary care physician.

The system may obtain this information in any manner. In some embodiments, the system may query a database schema, access pre-defined metadata, or retrieve logical data models to obtain this information. For example, the system may extract table structures, field definitions, and foreign key relationships from a relational database schema to construct the data model. Alternatively, the system may process metadata files that describe the attributes and relationships of entities in a data lake or distributed data source.

At block 740, the method involves generating machine-readable access control policies such as Rego policies, Immuta® policies, and data layer criteria. In some embodiments, this step includes using the extracted components and data models to produce machine-readable artifacts. For example, the system may generate Rego policies for enforcement in a policy management system, Immuta® policies for access control in a data lake environment, and SQL queries for enforcing access control rules at the data source level. The process may interact with a Policy Generation AI Module via an API to perform this operation. For example, an API exposed by the Policy Generation AI Module may accept the extracted components, data models, and a structured prompt as input and return the generated artifacts. The process may display these artifacts in the UI, allowing users to review and approve them.

At block 750, the method involves verifying the policy. In some embodiments, this step includes generating test cases and test data to evaluate the machine-readable artifacts. For example, the system may simulate real-world scenarios to ensure that the policies comply with the user access policies and the data model descriptions. The process may interact with a Test Case Generation AI Module and a Test Data Generation AI Module via APIs to perform this operation. For example, the Test Case Generation AI Module may generate test cases based on the machine-readable artifacts, while the Test Data Generation AI Module may create synthetic test data that mimics real-world scenarios. The process may execute the test cases against the test data and display the results in the UI, highlighting any discrepancies or failures.

At block 760, the method involves evaluating the verification results. In some embodiments, this step includes analyzing the outcomes of the test cases to identify any discrepancies or failures. For example, if a test case reveals that a user with insufficient permissions can access restricted data, the system may prompt for policy modifications. The process may include a notification feature in the UI to alert users to any issues identified during verification. Users may then provide feedback or corrections through the UI, which the process can send back to the relevant AI modules via APIs for further refinement.

At block 770, the method involves publishing the policies to implementation layers. In some embodiments, this step includes deploying the verified policies to systems such as policy management platforms, data lakes, and databases. For example, the system may publish Rego policies to an Open Policy Agent (OPA) repository or Immuta® policies to a data governance platform. The process may interact with a Policy Publishing AI Module via an API to perform this operation. For instance, the API may accept the verified artifacts as input and handle their deployment to the appropriate implementation layers. The process may also log the publishing activity in a source control system for version management and auditing.

At block 780, the method involves promoting the policies to production. In some embodiments, this step includes deploying the published policies into a live environment for real-time enforcement of access control rules. For example, the system may integrate the policies into a source control system for version management and auditing. The process may interact with a Source Control System API to store the published policies and track changes. The UI may provide users with a dashboard to monitor the deployment status and ensure that the policies are functioning as intended in the production environment.

While FIG. 7 provides a high-level overview of the system's operation, each action is described in greater detail with reference to FIGS. 8-10B. These figures provide additional context and examples for the specific steps involved in the method 700.

FIG. 8 illustrates an example method 800 for automating policy management for user entitlements, with operations that roughly correspond to actions 710 and 720 in FIG. 7. The method begins with selecting a domain to entitle at block 810. In some embodiments, this step involves a user interacting with a user interface (UI) to specify the domain for which access control policies are to be generated. For example, the user may select a financial domain, a healthcare domain, or another operational environment. This selection provides the context for subsequent operations and ensures that the generated policies align with the specific requirements of the chosen domain.

At block 820, the method involves providing user access policies in plain English. This step corresponds to the operation described in block 710 of FIG. 7, where human-readable descriptions of access control rules are received. For example, a user may input a policy stating that "Only users with a 'Manager' role can access financial reports." The UI may include a text input field or a file upload feature to facilitate this step. The process may then interact with the Integrity Check AI Module 634 from FIG. 6 via an API to analyze the plain English descriptions for ambiguities, inconsistencies, or conflicts. For instance, the API may return a report identifying issues in the descriptions, which the UI can display to the user for review and correction. In some embodiments, when ambiguities, inconsistencies, or conflicts are identified, the Integrity Check AI Module or other AI module may suggest corrective actions to resolve any identified ambiguities, inconsistencies, or conflicts. Also for example, any identified ambiguities, inconsistencies, or conflicts may be presented to a user via a user interface to allow the use to provide any corrective actions.

At block 830, the method involves verifying the policy for roles, actions, and permissions. This step corresponds to the operation described in block 720 of FIG. 7, where actors, actions, and assets are extracted from the plain English descriptions and validated. For example, the system may extract a "Finance Analyst" role, the action "view," and the asset "transaction records." The API may accept the plain English descriptions as input and return the extracted components, which the process can validate and display to the user through an interactive table in the UI. Any ambiguities or conflicts identified during this step may be flagged for resolution, ensuring that the extracted components are complete and consistent.

At decision block 840, the method determines whether the policy has been verified. If the policy is not verified, the process may prompt the user to revise the plain English descriptions or provide additional information. For example, the UI may display a notification highlighting the specific issues that need to be addressed. Once the policy is verified, the method proceeds to block 850.

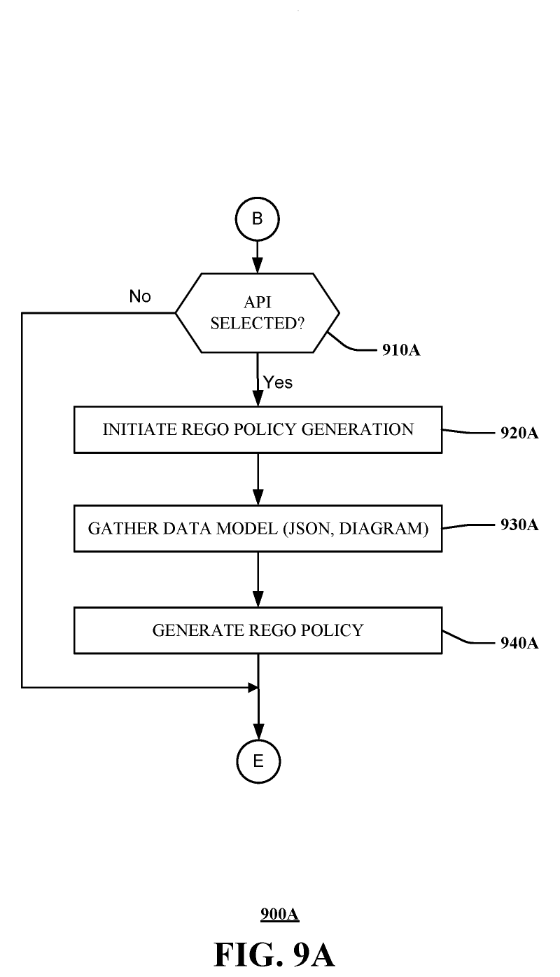

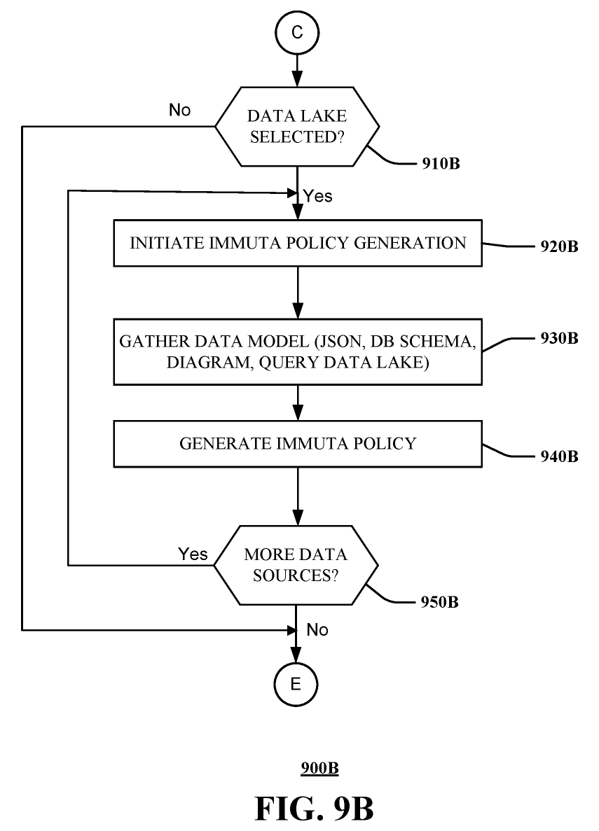

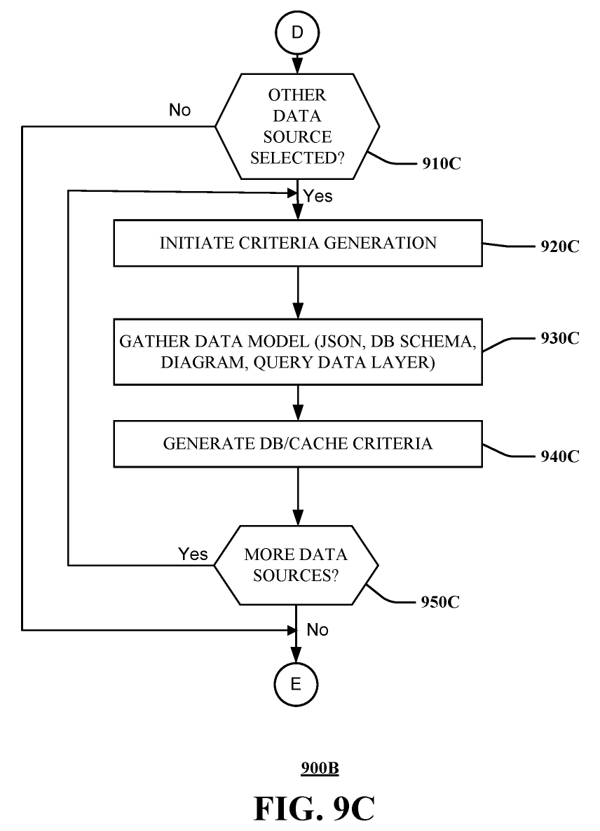

At block 850 in FIG. 8, the method involves selecting a mechanism for exposing data, which determines how the system will process the data models and generate access control policies. Based on the selection made at block 850, one of three possibilities exists, as shown by paths B, C, and D. Path B corresponds to the method shown in FIG. 9A, where the system generates Rego policies for APIs. Path C corresponds to the method shown in FIG. 9B, where the system generates Immuta® policies for data lakes. Path D corresponds to the method shown in FIG. 9C, where the system generates database or cache criteria for other data sources. While these three examples are provided, the various embodiments are not limited to these three possibilities, and additional mechanisms for exposing data may also be supported.

For example, in some embodiments, the system may support generating access control policies for data visualization tools. In this case, the data model may describe the structure of dashboards, charts, and reports, and the system may generate policies that restrict access to specific visualizations based on user roles and permissions. For instance, a "Marketing Analyst" role may only be allowed to view sales data for their assigned region, while a "Manager" role may have access to aggregated sales data across all regions.

In another example, the system may support generating policies for cloud-based storage systems. Here, the data model may describe the structure of storage buckets, files, and folders, and the system may generate policies that control access to these resources. For instance, a "Developer" role may have read and write access to a specific project folder, while a "Viewer" role may only have read access to the same folder.

Additionally, the system may support generating policies for streaming data platforms. In this case, the data model may describe the structure of data streams, topics, and partitions, and the system may generate policies that govern access to these streams. For example, a "Data Engineer" role may have access to publish and subscribe to a specific topic, while a "Data Analyst" role may only have access to subscribe to the topic.

In some embodiments, the system may also support generating policies for machine learning platforms. The data model may describe the structure of datasets, models, and training pipelines, and the system may generate policies that control access to these resources. For instance, a "Data Scientist" role may have access to train and evaluate models using specific datasets, while a "Reviewer" role may only have access to view the evaluation results.

FIG. 9A illustrates an example method 900A for generating Rego policies, which corresponds to the selection of the Rego Policy Generation AI module API mechanism for exposing data, as determined in block 850 of FIG. 8. The method begins at decision block 910A, where the system determines whether the API for the Rego Policy Generation AI Module has been selected. If the API is not selected, the remaining actions of method 900A are bypassed. If the API is selected, the method continues with the subsequent actions of method 900A to generate a machine-readable artifact that includes a Rego policy.

At block 920A, the method involves initiating the Rego policy generation process. In some embodiments, this step includes preparing the necessary inputs, such as plain English descriptions of user access policies and data model descriptions, for communication with the Rego Policy Generation AI Module. For example, the system may compile the extracted actors, actions, and assets from the plain English descriptions, along with the structural details of the data model, into a structured format suitable for processing by the AI module.

At block 930A, the method involves gathering the data model, which may include representations such as JSON files, diagrams, or other structured formats that describe the relationships, attributes, and structure of the data sources governed by the access policies. For example, the data model may specify entities such as "Users," "Roles," and "Permissions," along with their interrelationships. This information is useful for ensuring that the generated Rego policy aligns with the underlying data architecture.

At block 940A, the method involves generating the Rego policy by communicating the appropriate information to the Rego Policy Generation AI Module. In some embodiments, this step includes transmitting the plain English descriptions, the structured data model, and any additional contextual information to the AI module via an API. The Rego Policy Generation AI Module processes these inputs to produce a machine-readable artifact that includes a Rego policy. For example, the generated Rego policy may define access control rules specifying that only users with an "Admin" role can access sensitive financial data, while users with a "Viewer" role are restricted to read-only access to non-sensitive data.

The result of the operations in FIG. 9A is a machine-readable artifact that includes a Rego policy, which can be deployed to a policy management system for enforcement. This artifact ensures that access control rules are implemented in a consistent and machine-readable format, enabling robust and scalable policy enforcement.

FIG. 9B illustrates an example method 900B for generating Immuta® policies, which corresponds to the selection of the Immuta® Policy Generation AI module API mechanism for exposing data, as determined in block 850 of FIG. 8. The method begins at decision block 910B, where the system determines whether the API for the Immuta® Policy Generation AI Module has been selected. If the API is not selected, the remaining actions of method 900B are bypassed. If the API is selected, the method continues with the subsequent actions of method 900B to generate a machine-readable artifact that includes an Immuta® policy.

At block 920B, the method involves initiating the Immuta® policy generation process. In some embodiments, this step includes preparing the necessary inputs, such as plain English descriptions of user access policies and data model descriptions, for communication with the Immuta® Policy Generation AI Module. For example, the system may compile the extracted actors, actions, and assets from the plain English descriptions, along with the structural details of the data model, into a structured format suitable for processing by the AI module.

At block 930B, the method involves gathering the data model, which may include representations such as JSON files, database schemas, diagrams, or other structured formats that describe the relationships, attributes, and structure of the data sources governed by the access policies. For example, the data model may specify entities such as "Users," "Roles," and "Permissions," along with their interrelationships. This information is useful for ensuring that the generated Immuta® policy aligns with the underlying data architecture and governance requirements.

At block 940B, the method involves generating the Immuta® policy by communicating the appropriate information to the Immuta® Policy Generation AI Module. In some embodiments, this step includes transmitting the plain English descriptions, the structured data model, and any additional contextual information to the AI module via an API. The Immuta® Policy Generation AI Module processes these inputs to produce a machine-readable artifact that includes an Immuta® policy. For example, the generated Immuta® policy may define access control rules specifying that only users with a "Finance Analyst" role can access transaction records, and even then, only anonymized data fields may be visible unless the user has additional clearance.

The result of the operations in FIG. 9B is a machine-readable artifact that includes an Immuta® policy, which can be deployed to a data lake environment for enforcement. This artifact ensures that access control rules are implemented in a consistent and machine-readable format, enabling robust and scalable policy enforcement tailored to large-scale, distributed data sources.

FIG. 9C illustrates an example method 900C for generating database or cache criteria for other data sources, which corresponds to the selection of the appropriate API mechanism for exposing data, as determined in block 850 of FIG. 8. The method begins at decision block 910C, where the system determines whether the API for generating database or cache criteria has been selected. If the API is not selected, the remaining actions of method 900C are bypassed. If the API is selected, the method continues with the subsequent actions of method 900C to generate a machine-readable artifact that includes database or cache criteria.

At block 920C, the method involves initiating the criteria generation process. In some embodiments, this step includes preparing the necessary inputs, such as plain English descriptions of user access policies and data model descriptions, for communication with the appropriate AI module. For example, the system may compile the extracted actors, actions, and assets from the plain English descriptions, along with the structural details of the data model, into a structured format suitable for processing by the AI module.

At block 930C, the method involves gathering the data model, which may include representations such as JSON files, database schemas, diagrams, or other structured formats that describe the relationships, attributes, and structure of the data sources governed by the access policies. For example, the data model may specify entities such as "Users," "Roles," and "Permissions," along with their interrelationships. This information is useful for ensuring that the generated database or cache criteria align with the underlying data architecture and operational requirements.

At block 940C, the method involves generating the database or cache criteria by communicating the appropriate information to the relevant AI module. In some embodiments, this step includes transmitting the plain English descriptions, the structured data model, and any additional contextual information to the AI module via an API. The AI module processes these inputs to produce a machine-readable artifact that includes database or cache criteria. For example, the generated criteria may define access control rules specifying that only users with a "Data Engineer" role can access specific database tables, while users with a "Data Analyst" role are restricted to querying aggregated data views.

At block 950C, the method determines whether additional data sources need to be processed. If more data sources are identified, the method loops back to block 920C to repeat the criteria generation process for the next data source. For example, if the system is managing access control for multiple databases or caching layers, the process may iterate through each data source to ensure that appropriate criteria are generated for all of them. If no additional data sources are identified, the method proceeds to the next stage of the overall workflow, as described in FIG. 8.

The result of the operations in FIG. 9C is a machine-readable artifact that includes database or cache criteria, which can be deployed to a database or caching system for enforcement. This artifact ensures that access control rules are implemented in a consistent and machine-readable format, enabling robust and scalable policy enforcement tailored to other types of data sources. The inclusion of block 950C ensures that the method can handle multiple data sources efficiently, providing comprehensive support for complex environments with diverse data management needs.

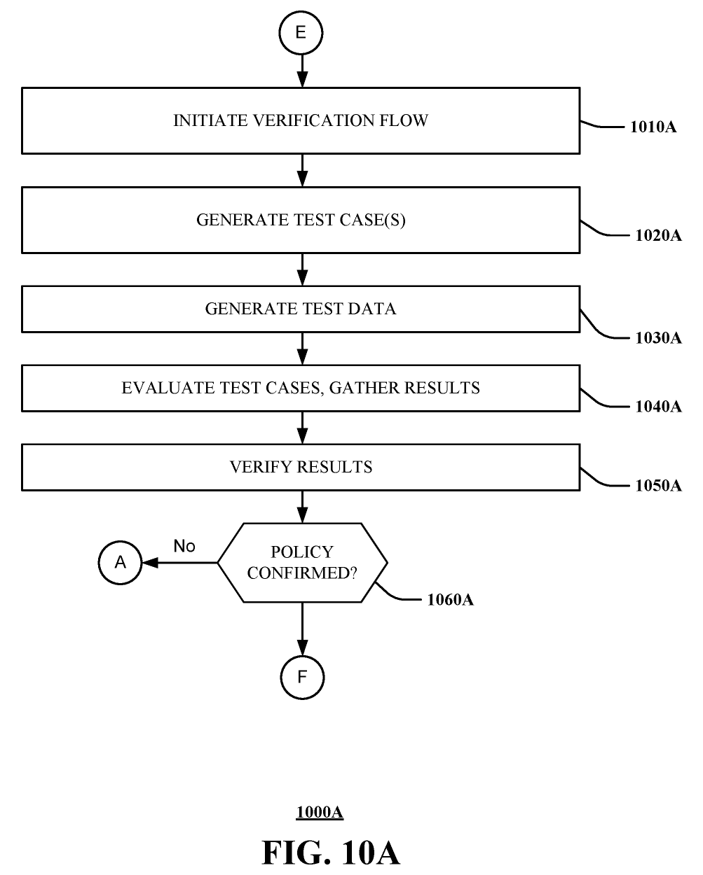

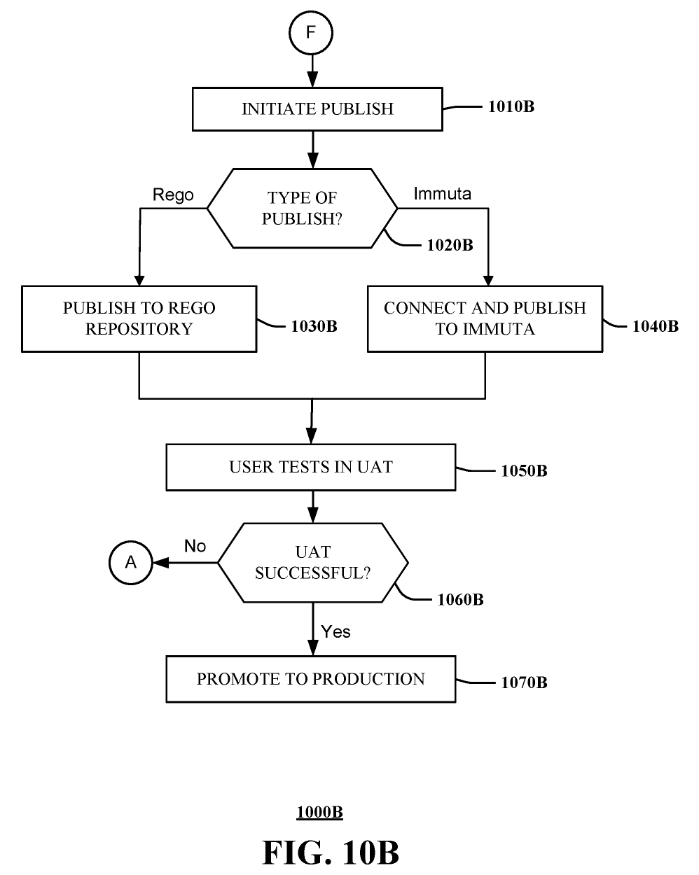

FIG. 10A illustrates an example method 1000A for verifying machine-readable access control policies, providing a detailed flow of the verification process. The operations in FIG. 10A may be performed by a processing system interacting with various AI tools, as described in FIG. 6, and correspond to the verification steps outlined in FIG. 7.

At block 1010A, the method begins by initiating the verification flow. In some embodiments, this step involves receiving machine-readable access control policies and associated data model descriptions as inputs. For example, the system may retrieve Rego policies, Immuta® policies, or database criteria generated in earlier steps, along with the data models that describe the structure and relationships of the governed data sources. The process may include a user interface (UI) component that allows users to trigger the verification process and monitor its progress.

At block 1020A, the method involves generating test cases. In some embodiments, this step is performed by interacting with a Test Case Generation AI Module via an API. The AI module may analyze the machine-readable policies and the data model descriptions to create test cases that simulate various access scenarios. For example, the test cases may include scenarios where a user with a specific role attempts to access restricted data or perform unauthorized actions. The generated test cases are designed to validate compliance with the access control rules defined in the policies.

At block 1030A, the method involves generating test data. In some embodiments, this step is performed by interacting with a Test Data Generation AI Module via an API. The AI module may create synthetic test data that mimics real-world data while preserving privacy and security requirements. For example, the test data may include anonymized user records, transaction logs, or other domain-specific datasets. The generated test data is used in conjunction with the test cases to evaluate the policies.

At block 1040A, the method involves evaluating the test cases and gathering results. In some embodiments, the system executes the test cases against the test data to verify the machine-readable policies. For example, the system may simulate access requests and compare the outcomes to the expected results defined in the test cases. The evaluation process may identify discrepancies, such as policies that allow unauthorized access or block legitimate actions. The results of the evaluation are collected and analyzed to determine the effectiveness of the policies.

At block 1050A, the method involves verifying the results. In some embodiments, this step includes analyzing the evaluation results to confirm that the policies comply with the user access policies and the data model descriptions. For example, the system may ensure that all test cases pass without errors and that the policies enforce the intended access control rules. Any issues identified during this step may be flagged for further review and correction.

At decision block 1060A, the method determines whether the policies are confirmed. If the policies are verified successfully, the method proceeds to the next stage of the workflow, such as publishing the policies to implementation layers as described in FIG. 7. If the policies are not confirmed, the system may prompt the user to revise the policies or provide additional information. For example, the UI may display a summary of the issues identified during verification, along with recommendations for resolving them.

The operations in FIG. 10A provide a structured and systematic approach to verifying machine-readable access control policies, ensuring that they are accurate, consistent, and compliant with the defined access control rules. By leveraging AI tools for test case and test data generation, the method enhances the efficiency and reliability of the verification process, supporting robust policy enforcement in diverse operational environments.

FIG. 10B illustrates an example method 1000B for publishing and promoting access control policies, providing a detailed flow of the operations involved in deploying verified policies into production. The operations in FIG. 10B correspond to the publishing and promotion steps outlined in FIG. 7 and involve interactions with various implementation layers and user acceptance testing (UAT).

At block 1010B, the method begins by initiating the publishing process. In some embodiments, this step involves receiving verified access control policies, such as Rego policies, Immuta® policies, or database criteria, that have been generated and verified in earlier steps. The process may include a user interface (UI) component that allows users to trigger the publishing process and monitor its progress.

At block 1020B, the method involves determining the type of publishing required. For example, the system may determine whether the policies are to be published to a Rego repository, an Immuta® environment, or another implementation layer. This decision may be based on the type of policies generated and the target system for enforcement. The selection at this block determines the subsequent path taken by the method.

If the system determines that the policies are to be published to a Rego repository, the method proceeds to block 1030B. At this block, the system connects to the Rego repository and publishes the verified Rego policies. In some embodiments, this step involves interacting with a Policy Publishing AI Module via an API to handle the deployment of the policies to the repository. For example, the API may accept the verified Rego policies as input and ensure that they are stored in the appropriate repository for enforcement in a policy management system.

If the system determines that the policies are to be published to an Immuta® environment, the method proceeds to block 1040B. At this block, the system connects to the Immuta® environment and publishes the verified Immuta® policies. In some embodiments, this step also involves interacting with the Policy Publishing AI Module via an API to handle the deployment. For example, the API may ensure that the Immuta® policies are integrated into the data lake environment for fine-grained access control.

At block 1050B, the method involves user acceptance testing (UAT). In some embodiments, this step includes allowing users to test the published policies in a controlled environment to ensure that they function as intended. For example, users may simulate access requests to verify that the policies enforce the correct access control rules. The results of the UAT may be displayed to the users through the UI, providing feedback on the effectiveness of the policies.

At decision block 1060B, the method determines whether the UAT was successful. If the UAT reveals issues or failures, the method may loop back to earlier steps for policy modification and re-verification. For example, the system may prompt users to revise the policies or provide additional information to address the identified issues. If the UAT is successful, the method proceeds to block 1070B.

At block 1070B, the method involves promoting the policies to production. In some embodiments, this step includes deploying the published policies into a live environment for real-time enforcement of access control rules. For example, the system may integrate the policies into a source control system for version management and auditing. The UI may provide users with a dashboard to monitor the deployment status and ensure that the policies are functioning as intended in the production environment.

The operations in FIG. 10B provide a structured and systematic approach to publishing and promoting access control policies, ensuring that they are deployed accurately and effectively. By incorporating UAT and leveraging AI tools for policy publishing, the method enhances the reliability and scalability of policy enforcement across diverse operational environments.

The terms “first,” “second,” “third,” and so forth, as used in the claims, unless otherwise clear by context, is for clarity only and does not otherwise indicate or imply any order in time. For instance, “a first determination,” “a second determination,” and “a third determination,” does not indicate or imply that the first determination is to be made before the second determination, or vice versa, etc.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can comprise both volatile and nonvolatile memory, by way of illustration, and not limitation, volatile memory, non-volatile memory, disk storage, and memory storage. Further, nonvolatile memory can be included in read only memory (ROM), programmable ROM (PROM), electrically programmable ROM (EPROM), electrically erasable ROM (EEPROM), or flash memory. Volatile memory can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Moreover, it will be noted that the disclosed subject matter can be practiced with other computer system configurations, comprising single-processor or multiprocessor computer systems, mini-computing devices, mainframe computers, as well as personal computers, hand-held computing devices (e.g., PDA, phone, smartphone, watch, tablet computers, netbook computers, etc.), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

In one or more embodiments, information regarding use of services can be generated including services being accessed, media consumption history, user preferences, and so forth. This information can be obtained by various methods including user input, detecting types of communications (e.g., video content vs. audio content), analysis of content streams, sampling, and so forth. The generating, obtaining and/or monitoring of this information can be responsive to an authorization provided by the user. In one or more embodiments, an analysis of data can be subject to authorization from user(s) associated with the data, such as an opt-in, an opt-out, acknowledgement requirements, notifications, selective authorization based on types of data, and so forth.

Some of the embodiments described herein can also employ artificial intelligence (AI) to facilitate automating one or more features described herein. The embodiments (e.g., in connection with automatically identifying acquired cell sites that provide a maximum value/benefit after addition to an existing communication network) can employ various AI-based schemes for carrying out various embodiments thereof. Moreover, the classifier can be employed to determine a ranking or priority of each cell site of the acquired network. A classifier is a function that maps an input attribute vector, x = (x₁, x₂, x₃, x₄ … xₙ), to a confidence that the input belongs to a class, that is, f(x) = confidence (class). Such classification can employ a probabilistic and/or statistical-based analysis (e.g., factoring into the analysis utilities and costs) to determine or infer an action that a user desires to be automatically performed. A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches comprise, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated, one or more of the embodiments can employ classifiers that are explicitly trained (e.g., via a generic training data) as well as implicitly trained (e.g., via observing UE behavior, operator preferences, historical information, receiving extrinsic information). For example, SVMs can be configured via a learning or training phase within a classifier constructor and feature selection module. Thus, the classifier(s) can be used to automatically learn and perform a number of functions, including but not limited to determining according to predetermined criteria which of the acquired cell sites will benefit a maximum number of subscribers and/or which of the acquired cell sites will add minimum value to the existing communication network coverage, etc.

As used in some contexts in this application, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or computer-readable storage/communications media. For example, computer readable storage media can include, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or”. That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, terms such as “user equipment,” “mobile station,” “mobile,” subscriber station,” “access terminal,” “terminal,” “handset,” “mobile device” (and/or terms representing similar terminology) can refer to a wireless device utilized by a subscriber or user of a wireless communication service to receive or convey data, control, voice, video, sound, gaming or substantially any data-stream or signaling-stream. The foregoing terms are utilized interchangeably herein and with reference to the related drawings.

Furthermore, the terms “user,” “subscriber,” “customer,” “consumer” and the like are employed interchangeably throughout, unless context warrants particular distinctions among the terms. It should be appreciated that such terms can refer to human entities or automated components supported through artificial intelligence (e.g., a capacity to make inference based, at least, on complex mathematical formalisms), which can provide simulated vision, sound recognition and so forth.

As employed herein, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components or any combination thereof designed to perform the functions described herein. Processors can exploit nano-scale architectures such as, but not limited to, molecular and quantum-dot based transistors, switches and gates, in order to optimize space usage or enhance performance of user equipment. A processor can also be implemented as a combination of computing processing units.

As used herein, terms such as “data storage,” data storage,” “database,” and substantially any other information storage component relevant to operation and functionality of a component, refer to “memory components,” or entities embodied in a “memory” or components comprising the memory. It will be appreciated that the memory components or computer-readable storage media, described herein can be either volatile memory or nonvolatile memory or can include both volatile and nonvolatile memory.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to”, “coupled to”, and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

What is claimed is:

1. A non-transitory machine-readable medium storing executable instructions which, when executed by a computing device having at least one processor, cause the computing device to perform operations comprising:
receiving plain English descriptions of access policies for a specified domain, the plain English descriptions defining access control parameters for users, roles, and permissions;
transmitting the received plain English descriptions together with a predefined structured prompt to a generative artificial intelligence (AI) module;
obtaining, from the generative AI module, a set of identified components including user designations, permitted actions, and associated assets extracted from the plain English descriptions;
supplying the generative AI module with data model specifications that include structure, interrelationships, and attributes of data sources governed by the access policies;
receiving, from the generative AI module, machine-readable access control policies produced based on the plain English descriptions and the data model specifications;
verifying the machine-readable access control policies by generating and executing test cases against designated test data to confirm compliance with the access policies and the data model specifications, thereby producing verified access control policies;
publishing the verified access control policies to one or more implementation layers to produce published access control policies; and
deploying the published access control policies into a production environment for real-time enforcement of access control rules.

2. The non-transitory machine-readable medium of claim 1, wherein the AI module includes an integrity check tool configured to analyze the plain English descriptions to identify at least one of ambiguities, inconsistencies, or conflicts in the access control parameters.

3. The non-transitory machine-readable medium of claim 1, wherein the AI module includes a test case generation tool configured to generate the test cases based on the machine-readable access control policies and the data model specifications, the test cases being used to verify compliance with the access control parameters.

4. The non-transitory machine-readable medium of claim 1, wherein the AI module includes a query generation tool configured to produce data layer criteria, including structured query language (SQL) queries and distributed search engine queries, for enforcing the access control parameters.

5. The non-transitory machine-readable medium of claim 1, wherein the operations further comprise storing the verified access control policies in a source control system, wherein the source control system manages version control and tracks changes to the machine-readable access control policies.

6. The non-transitory machine-readable medium of claim 1, wherein the operations further comprise dynamically updating the machine-readable access control policies in response to changes in the data model specifications by supplying updated data model specifications to the AI module.

7. A non-transitory machine-readable medium, comprising executable instructions that, when executed by a server including a processor, facilitate performance of operations, the operations comprising:
receiving plain English descriptions of access policies for a specified domain, the plain English descriptions defining access control parameters for users, roles, and permissions;
providing the plain English description to an integrity check AI module configured to analyze the plain English descriptions to identify at least one of ambiguities, inconsistencies, or conflicts in the access control parameters;
providing the plain English descriptions together with data model specifications and a structured prompt to a policy generation AI module;
receiving, from the policy generation AI module, machine-readable access control policies produced based on the plain English descriptions and the data model specifications, the machine-readable access control policies specifying access control rules for the users, the roles, and the permissions; and
verifying the machine-readable access control policies by interacting with a test case generation AI module to generate test cases and a test data generation AI module to create designated test data.

8. The non-transitory machine-readable medium of claim 7, wherein the machine-readable access control policies are Rego policies configured for enforcement in a policy management system.

9. The non-transitory machine-readable medium of claim 7, wherein the machine-readable access control policies are Immuta® policies configured for access control in a data lake environment.

10. The non-transitory machine-readable medium of claim 7, wherein the machine-readable access control policies are data layer criteria, including structured query language (SQL) queries and distributed search engine queries, configured for enforcing access control rules.

11. The non-transitory machine-readable medium of claim 7, the operations further comprising publishing verified access control policies to one or more implementation layers to produce published access control policies.

12. The non-transitory machine-readable medium of claim 11, the operations further comprising deploying the published access control policies into a production environment for real-time enforcement of access control rules.

13. A method, comprising:
receiving, by a processing system including a processor, plain English descriptions of user access policies for a domain, wherein the plain English descriptions define access control rules for users, roles, and permissions within the domain;
providing, by the processing system, to a generative artificial intelligence (AI) system, the plain English descriptions along with a structured prompt;
receiving, by the processing system, from the generative AI system, extracted actors, actions, and assets from the plain English descriptions;
providing, by the processing system, to the generative AI system, data model descriptions that describe structure, relationships, and attributes of data sources governed by the user access policies;
receiving, by the processing system, from the generative AI system, machine-readable artifacts generated based on the plain English descriptions and the data model descriptions;
verifying, by the processing system, the machine-readable artifacts by generating test cases, and executing the test cases against test data to ensure compliance with the user access policies and the data model descriptions to produce verified artifacts;
publishing, by the processing system, the verified artifacts to implementation layers, wherein the implementation layers comprise at least one of policy management systems, data lakes, databases, or any combination thereof to produce published artifacts; and
promoting, by the processing system, the published artifacts to a production environment, wherein the published artifacts are deployed for real-time enforcement of the access control parameters.

14. The method of claim 13, wherein the structured prompt specifies standards, formats, and contextual information for generating the machine-readable artifacts.

15. The method of claim 13, wherein the data model descriptions are obtained by querying at least one of a database schema, receiving logical data models, or accessing pre-defined metadata.

16. The method of claim 13, wherein the machine-readable artifacts comprise at least one of Rego policies for enforcement in a policy management system or Immuta® policies for data lake access control, or any combination thereof.

17. The method of claim 13, wherein the generative AI system includes an integrity check tool configured to analyze the plain English descriptions to identify at least one of ambiguities, inconsistencies, or conflicts in the access control rules.

18. The method of claim 13, wherein the generative AI system includes a test case generation tool configured to generate the test cases based on the machine-readable artifacts and the data model descriptions, the test cases being used to verify compliance with the user access policies.

19. The method of claim 13, wherein the generative AI system includes a test data generation tool configured to create the test data that simulates real-world scenarios for evaluating the machine-readable artifacts against the user access policies and the data model descriptions.

20. The method of claim 13, wherein the generative AI system includes a policy publishing tool configured to publish the machine-readable artifacts, including at least one of Rego policies, Immuta® policies, or data layer criteria.
